(19) United States
(12) Patent Application Publication
(10) Pub. No.: US 2017/0223212 A1
(43) Pub. Date: Aug. 3, 2017

(54) EXPOSURE DEVICE, IMAGE FORMING APPARATUS, AND MULTI-FUNCTION APPARATUS

(71) Applicant: Oki Data Corporation, Tokyo (JP)

(72) Inventor: Akio NAKATANI, Tokyo (JP)

(73) Assignee: Oki Data Corporation, Tokyo (JP)

(21) Appl. No.: 15/382,599

(22) Filed: Dec. 16, 2016

(30) Foreign Application Priority Data
Jan. 29, 2016 (JP) 2016-015328

(51) Int. Cl. H04N 1/024; F21V 17/02; H04N 1/29; H04N 1/03; H04N 1/06

(52) U.S. Cl. CPC H04N 1/02409; H04N 1/0249; H04N 1/0306; H04N 1/06; H04N 1/29; F21V 17/02; H04N 2201/0094

(57) ABSTRACT

An exposure device includes: a first light emitting element; a first lens array that converges light emitted from the first light emitting element; a second light emitting element; a second lens array that converges light emitted from the second light emitting element; a holder that holds the first light emitting element, the first lens array, the second light emitting element, and the second lens array; and a first adjustment mechanism that is provided in the holder and adjusts a first distance between the first lens array and the first light emitting element.

### BACKGROUND OF THE INVENTION

1. Field of the Invention

The present invention relates to an exposure device including multiple light emitting elements, an image forming apparatus including the exposure device, and a multi-function apparatus including the image forming apparatus.

2. Description of the Related Art

A conventional image forming apparatus using an electrophotographic process includes an exposure device that illuminates a uniformly charged photosensitive drum with light corresponding to image data to form an electrostatic latent image on the photosensitive drum. The exposure device is, for example, a light emitting diode (LED) head. The LED head includes a substrate (or LED unit substrate) on which an LED array unit including multiple LEDs as multiple light emitting elements arranged one-dimensionally is mounted, a base as a support that supports the substrate, a lens array that converges light from the LED array unit on a surface of the photosensitive drum, and a lens holder as a holder that holds the lens array. For example, Japanese Patent Application Publication No. 2013-109370 discloses an LED head including a lens array having two rows of microlenses.

In the LED head, light emitted from the LED array is imaged by the lens array and exposes the surface of the photosensitive drum, thereby forming an electrostatic latent image on the surface of the photosensitive drum.

By changing the number of LED array units mounted on an LED head or the number of LED chips mounted on an LED array unit, it is possible to provide an LED head having an exposure width required for printing. Thus, it is possible to produce not only short LED heads corresponding to small print sizes, such as A4 or A3 size, but also long LED heads corresponding to large print sizes, such as A1 or A0 size.

A long LED unit substrate can be produced at low cost by arranging multiple short LED unit substrates. For example, Japanese Patent Application Publication No. 2004-148698 discloses an LED head in which multiple LED unit substrates are arranged with respect to a single lens array. Also, a long lens array can be produced at low cost by arranging multiple short lens arrays.

However, when a long LED head is produced by arranging multiple LED unit substrates or multiple lens arrays, due to difference in thickness among the LED unit substrates, difference in thickness among the LED array units (or LED array chips), or difference in total conjugate length (TC), which is the distance between an object and an image plane, between the lens arrays, the difference between the distances from the surfaces of the lens arrays on the photosensitive drum side to the imaging points occurs around the boundary between adjacent LED unit substrates or lens arrays. Specifically, when a long LED head is produced as above, light emitted from two adjacent LEDs on both sides of the boundary between adjacent LED unit substrates or lens arrays forms, on the photosensitive drum, two spots having different diameters (or sizes). This causes a visible difference (unevenness) in print density at a portion corresponding to the boundary on a print medium, leading to poor print quality.

By, for example, replacing light emitting elements of an exposure device with light receiving elements, it is possible to provide a reading device including a light receiving substrate with multiple light receiving elements and a lens array. Also in such a reading device, when light receiving unit substrates or lens arrays are arranged, the difference between the distances from the light incident surfaces of the lens arrays to the light receiving elements occurs around the boundary between adjacent light receiving unit substrates or lens arrays, leading to a noticeable difference in reading accuracy.

### SUMMARY OF THE INVENTION

An aspect of the present invention is intended to provide an exposure device in which the position of an imaging point of light emitted from a light emitting element and passing through a lens array can be easily adjusted, an image forming apparatus including the exposure device, and a multi-function apparatus including the image forming apparatus.

According to an aspect of the present invention, there is provided an exposure device including: a first light emitting element; a first lens array that converges light emitted from the first light emitting element; a second light emitting element; a second lens array that converges light emitted from the second light emitting element; a holder that holds the first light emitting element, the first lens array, the second light emitting element, and the second lens array; and a first adjustment mechanism that is provided in the holder and adjusts a first distance between the first lens array and the first light emitting element.

According to another aspect of the present invention, there is provided an image forming apparatus including: the above exposure device; and an image carrier that is exposed by the exposure device and on which an electrostatic latent image is formed.

According to another aspect of the present invention, there is provided a multi-function apparatus including the above image forming apparatus.

### BRIEF DESCRIPTION OF THE DRAWINGS

In the attached drawings:

FIG. 1 is a sectional view schematically illustrating an exemplary configuration of an exposure device according to a first embodiment of the present invention;

FIG. 2 is a top view schematically illustrating LED unit substrates of the exposure device illustrated in FIG. 1;

FIG. 3 is a sectional view illustrating a cross-section of the exposure device along line I-I in FIG. 1;

FIG. 4 is a top view schematically illustrating an example of LED unit substrates and adjustment mechanisms of an exposure device according to a second embodiment of the present invention;

FIG. 5 is a view of the LED unit substrates and adjustment mechanisms illustrated in FIG. 4 as viewed in a −Y direction;

FIG. 6 is a top view schematically illustrating an example of LED unit substrates of an exposure device according to a third embodiment of the present invention;

FIG. 7 is a view illustrating a cross-section (corresponding to the cross-section in FIG. 3) of the exposure device according to the third embodiment of the present invention;

FIG. 8 is a top view schematically illustrating an example of LED unit substrates of an exposure device according to a fourth embodiment of the present invention;

FIG. 9 is a vertical sectional view schematically illustrating an exemplary configuration of an image forming apparatus according to a fifth embodiment of the present invention;

FIG. 10 is a vertical sectional view schematically illustrating an exemplary configuration of a document reading apparatus including a reading device according to a sixth embodiment of the present invention; and

FIG. 11 is a vertical sectional view schematically illustrating an exemplary configuration of the reading device of the document reading apparatus illustrated in FIG. 10.

### DETAILED DESCRIPTION OF THE INVENTION

Embodiments of the present invention will now be described with reference to the attached drawings. The drawings show the coordinate axes of an XYZ orthogonal coordinate system. In each of the drawings, the X axis is a coordinate axis in a longitudinal direction of an exposure device or a reading device according to one of the embodiments (a direction in which multiple light emitting elements or light receiving elements are arranged, or a main scanning direction of an image forming apparatus or a document reading apparatus); the Y axis is a coordinate axis in a lateral direction of the exposure device or reading device (a width direction, or a sub scanning direction of the image forming apparatus or document reading apparatus); the Z axis is a coordinate axis in a height direction of the exposure device or reading device (a direction opposite to a traveling direction of light emitted from the exposure device, or a traveling direction of light entering the reading device).

### First Embodiment

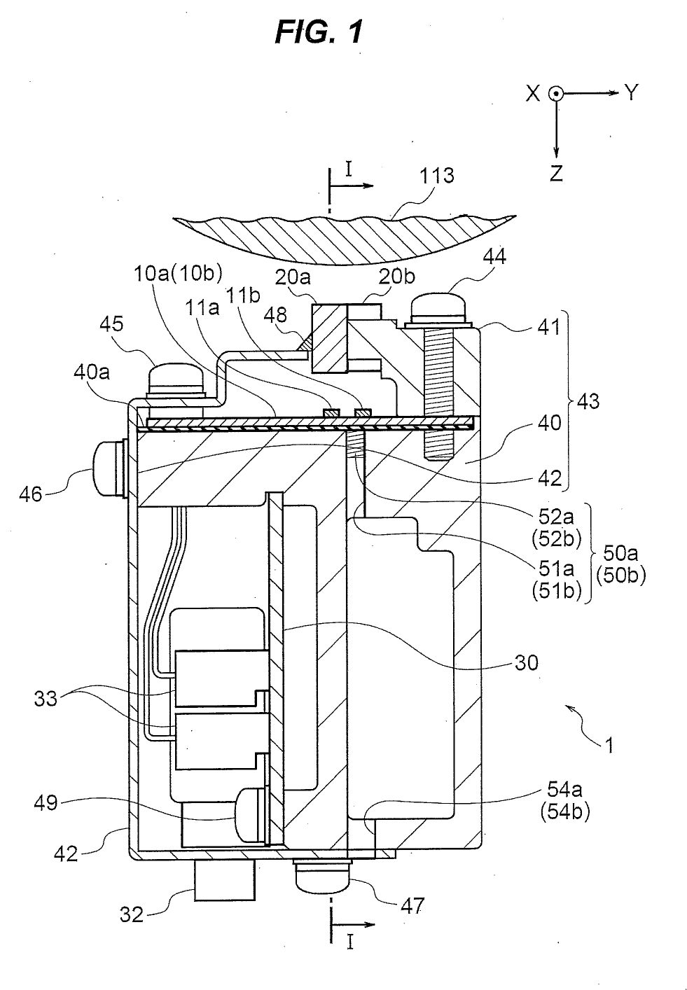

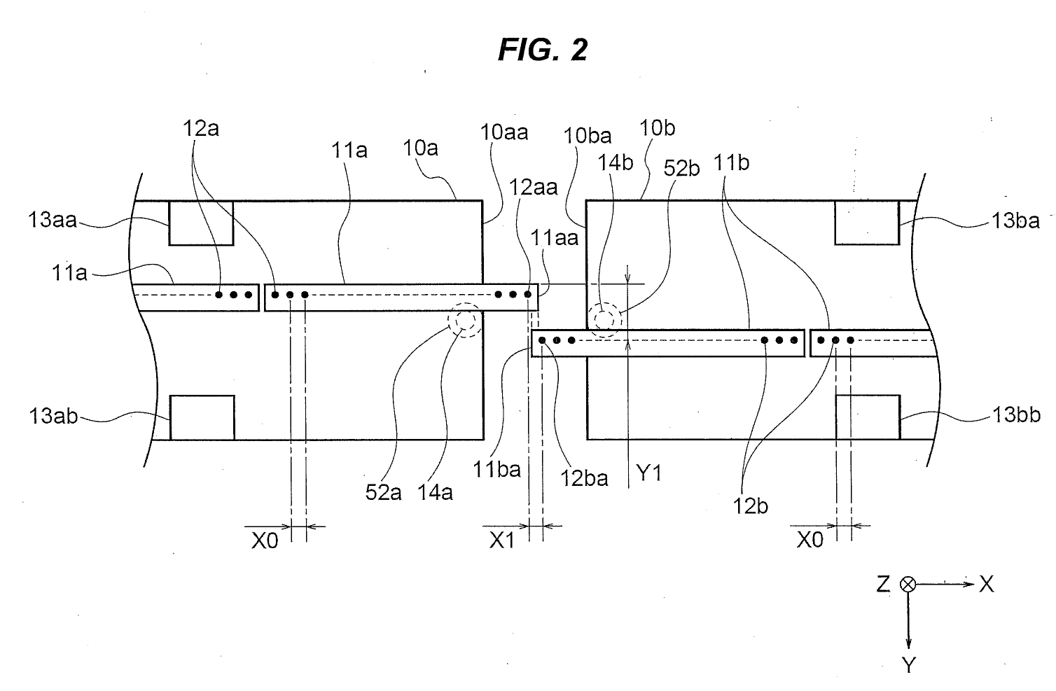

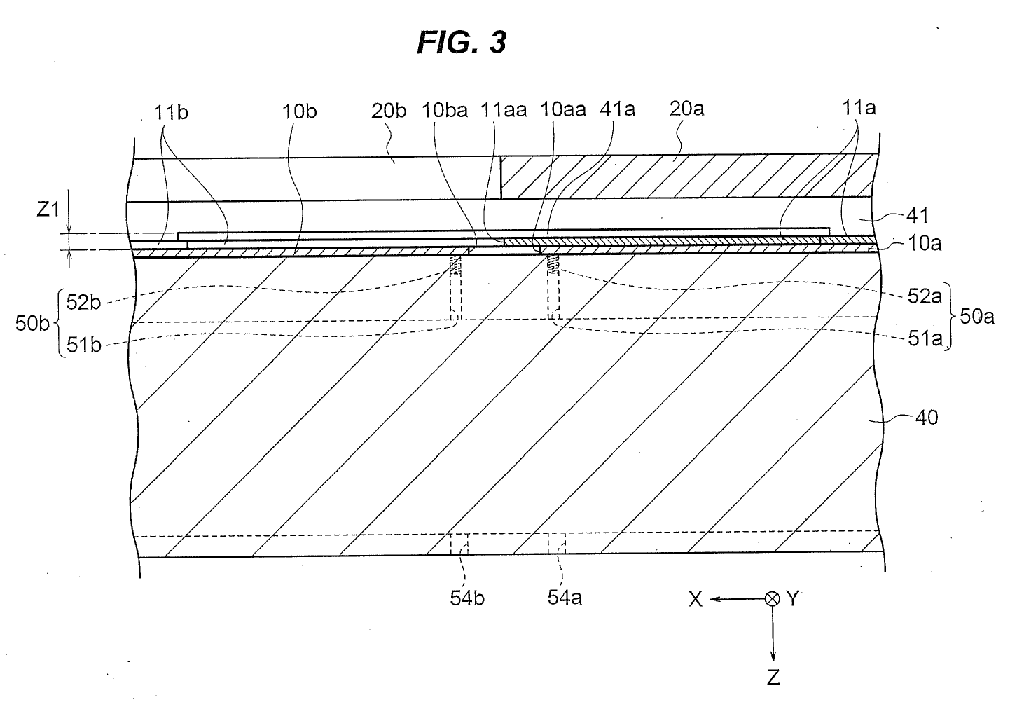

FIG. 1 is a sectional view schematically illustrating an exemplary configuration of an exposure device 1 according to a first embodiment. FIG. 2 is a top view schematically illustrating light emitting diode (LED) unit substrates in the exposure device 1 in FIG. 1. FIG. 3 is a sectional view of the exposure device 1 along line I-I in FIG. 1. FIGS. 2 and 3 each illustrate a part around a boundary between the LED unit substrates.

The exposure device 1 illustrated in FIG. 1 is a device (or an optical writing head) that exposes, for example, a surface of a photosensitive drum 113 as an image carrier with light emitted (or radiated) from light emitting elements. In the first embodiment, the light emitting elements are semiconductor light emitting elements, specifically LEDs. The same applies to other embodiments described later. In this case, the exposure device 1 is also referred to as a semiconductor light emitting device, an LED head, or an LED print head.

As illustrated in FIGS. 1 to 3, the exposure device 1 includes a first substrate (or first LED unit substrate) 10a on which at least one first light emitting element array unit is mounted, and a first lens array 20a that converges or focuses light emitted from the at least one first light emitting element array unit. In this example, multiple first LED array units 11a are mounted on the first substrate 10a as the at least one first light emitting element array unit.

The first substrate 10a is a substrate or board made of, for example, glass epoxy resin material. The first LED array units 11a are fixed to the first substrate 10a by being bonded with epoxy-based insulating adhesive, for example. The first LED array units 11a are electrically connected to a wiring pattern on the first substrate 10a by bonding wires (not illustrated).

As illustrated in FIG. 2, in each of the first LED array units 11a, multiple LEDs (first LEDs) 12a are arranged in a first direction as first light emitting elements. The first direction corresponds to the X axis direction. A longitudinal direction of the first substrate 10a is the same as the X axis direction, which is a longitudinal direction of the first LED array units 11a. As illustrated in FIG. 2, in each of the first LED array units 11a, centers (or positions of optical axes) of the LEDs 12a are equally spaced with a first array spacing X0, so that focal positions of light emitted from the respective LEDs 12a can be equally spaced in the X axis direction, and the positions of imaging points (or concentration points) of the light can be equally spaced in the X axis direction. The first LED array units 11a may be LED array chips. The LEDs 12a are driven by, for example, one or more drive circuits (not illustrated) mounted on the first substrate 10a, first LED array units 11a, or other components.

As illustrated in FIG. 2, the multiple first LED array units 11a are arranged in the X axis direction on the first substrate 10a. The multiple first LED array units 11a are arranged and fixed on the first substrate 10a so that the distance between the adjacent LEDs 12a at the adjacent ends of each adjacent two of the multiple first LED array units 11a is equal to the first array spacing X0.

The first lens array 20a converges or focuses light emitted from the LEDs 12a mounted on the first LED array units 11a. The first lens array 20a may be a lens array, such as a rod lens array or a microlens array, that performs one-to-one erect imaging. The first lens array 20a is disposed at a position in the Y axis direction facing the first LED array units 11a (more specifically, the multiple LEDs 12a) as illustrated in FIG. 1. Thereby, the first lens array 20a can converge light emitted from the first LED array units 11a.

As illustrated in FIGS. 1 to 3, the exposure device 1 also includes a second substrate (or second LED unit substrate) 10b on which at least one second light emitting element array unit is mounted, and a second lens array 20b that converges or focuses light emitted from the at least one second light emitting element array unit. In this example, multiple second LED array units 11b are mounted on the second substrate 10b as the at least one second light emitting element array unit. The second substrate 10b is spaced from the first substrate 10a in the first direction (or X axis direction). As such, the exposure device 1 can be configured as a long LED head. For example, when the first substrate 10a and second substrate 10b each have a length corresponding to A3 size, the exposure device 1 can perform exposure for A1 size. When the first substrate 10a has a length corresponding to A3 size, the length of the array of the LEDs 12a in the at least one first light emitting element array unit (or first LED array units 11a) mounted on the first substrate 10a corresponds to A3 size (the width or length of A3 size). The same applies to the second substrate 10b.

In this example, described in more detail below, the exposure device 1 includes the first LED array units 11a, first substrate 10a, first lens array 20a, second LED array units 11b, second substrate 10b, and second lens array 20b. However, the exposure device 1 may further include additional LED array units, LED unit substrates, and lens arrays. By arranging multiple LED unit substrates and multiple lens arrays, the exposure device 1 can be used as a long LED head. However, the exposure device 1 can also be used as a short LED head by arranging short LED unit substrates and short lens arrays.

Like the first substrate 10a, the second substrate 10b is a substrate or board made of, for example, glass epoxy resin material. The second LED array units 11b are fixed to the second substrate 10b. Like the first LED array units 11a, each of the second LED array units 11b includes, as second light emitting elements, multiple LEDs (second LEDs) 12b equally spaced with a second array spacing in the first direction (or X axis direction). The second array spacing is equal to the first array spacing X0. Thus, in the X axis direction, the intervals of the focal positions of light emitted from the respective LEDs 12b are equal to the intervals of the focal positions of light emitted from the respective LEDs 12a. Like the LEDs 12a, the LEDs 12b are driven by, for example, one or more drive circuits (not illustrated) mounted on the second substrate 10b or second LED array units 11b.

As illustrated in FIG. 2, the multiple second LED array units 11b are arranged on the second substrate 10b in the X axis direction so that the distance between the adjacent LEDs 12b at the adjacent ends of each adjacent two of the multiple second LED array units 11b is equal to the first array spacing X0. Thus, in a part around the boundary between each adjacent two of the second LED array units 11b, the focal positions are equally spaced in the X axis direction.

The second lens array 20b has the same configuration as the first lens array 20a, and converges or focuses light emitted from the LEDs 12b. As illustrated in FIG. 1, the second lens array 20b is disposed at a position (in the X axis direction and Y axis direction) facing the second LED array units 11b. Thereby, the second lens array 20b can converge or focus light emitted from the second LED array units 11b.

It is preferable that light passing through the first lens array 20a and light passing through the second lens array 20b be converged at the same position in the Y axis direction on the surface of the photosensitive drum 113. Thus, the first lens array 20a and second lens array 20b may be inclined so that their optical axes intersect with each other at the surface of the photosensitive drum 113. Alternatively, the internal configuration (shapes and arrangement of optical parts) of the exposure device 1 may be configured so that the optical axes of the first lens array 20a and second lens array 20b intersect with each other at the surface of the photosensitive drum 113.

However, light passing through the first lens array 20a and light passing through the second lens array 20b may be converged at different positions in the Y axis direction on the surface of the photosensitive drum 113. In this case, for example, the first LED array units 11a and second LED array units 11b are controlled to emit light at different times in consideration of the speed of rotation of the photosensitive drum 113 during the exposure. Thereby, it is possible to make the writing position of the light passing through the first lens array 20a and the writing position of the light passing through the second lens array 20b coincide with each other on the photosensitive drum 113 in a circumferential direction of the photosensitive drum 113.

The exposure device 1 also includes a holder that holds the first substrate 10a, first lens array 20a, second substrate 10b, and second lens array 20b. The holder is, for example, a holder 43 mainly composed of a base 40, a lens holder 41, and a cover 42, as illustrated in FIG. 1. The base 40 is an example of a support that supports the first substrate 10a and second substrate 10b. The lens holder 41 is an example of a holder that holds the first lens array 20a and second lens array 20b.

Features of the holder will be first described, and the holder 43 illustrated in FIG. 1, which is a specific example of the holder, will be then described in detail. The holder holds the first substrate 10a and first lens array 20a so that light emitted from the first LED array units 11a can be converged by the first lens array 20a on, for example, the surface of the photosensitive drum 113. The holder also holds the second substrate 10b and second lens array 20b so that light emitted from the second LED array units 11b can be converged by the second lens array 20b on, for example, the surface of the photosensitive drum 113.

The holder preferably holds the first substrate 10a and second substrate 10b so that the distance X1 in the X axis direction between a center of the LED 12aa illustrated in FIG. 2 and a center of the LED 12ba illustrated in FIG. 2 is equal to the first array spacing X0. The LED 12aa is mounted on the first LED array unit 11a (referred to below as the endmost first LED array unit 11a) closest to the second substrate 10b among the first LED array units 11a mounted on the first substrate 10a, and is the LED 12a closest to the second substrate 10b among the LEDs 12a in the endmost first LED array unit 11a. The LED 12ba is mounted on the second LED array unit 11b (referred to below as the endmost second LED array unit 11b) closest to the first substrate 10a among the second LED array units 11b mounted on the second substrate 10b, and is the LED 12b closest to the first substrate 10a among the LEDs 12b in the endmost second LED array unit 11b. To make the distance X1 equal to the spacing X0, an end surface 11aa of the endmost first LED array unit 11a on the second substrate 10b side may be on the second substrate 10b side of an end surface 11ba of the endmost second LED array unit 11b on the first substrate 10a side, in the X axis direction, as illustrated in FIG. 2.

Thereby, in a part around the boundary between the first substrate 10a and second substrate 10b, the focal positions can be equally spaced in the X axis direction. In view of assembly variation, “equally spaced” includes “substantially equally spaced.” Thus, the distance X1 may be substantially equal to the spacing X0. In other words, the second substrate 10b may be displaced from the first substrate 10a in the first direction so that the distance X1 is substantially equal to the spacing X0.

As illustrated in FIG. 2, the first substrate 10a and second substrate 10b may be arranged so that one end surface 10aa of the first substrate 10a in the X axis direction faces one end surface 10ba of the second substrate 10b in the X axis direction. The holder preferably holds the first substrate 10a and second substrate 10b while maintaining such an arrangement state. If the end surfaces 10aa and 10ba were in contact with each other, it would be difficult to adjust the distance X1. Thus, the holder preferably holds the first substrate 10a and second substrate 10b so that the end surfaces 10aa and 10ba are spaced from each other.

Thus, as illustrated in FIG. 2, the endmost first LED array unit 11a is preferably mounted on the first substrate 10a so that one end (or end portion including the end surface 11aa) of the endmost first LED array unit 11a in the X axis direction projects (in the +X direction in FIG. 2) from one end (specifically, the end surface 10aa of the end portion on the second substrate 10b side) of the first substrate 10a in the X axis direction. By reducing the length (or projecting length) of the projection, it is possible to reduce an area in which a bonding wire connecting the LED 12aa, which is disposed in the region of the endmost first LED array unit 11a projecting from the first substrate 10a, to the first substrate 10a is not fixed to the first substrate 10a, thereby reducing reduction in connection strength. The projecting length is preferably equal to or less than half the length of the endmost first LED array unit 11a in the X axis direction. For example, when the length of the endmost first LED array unit 11a in the X axis direction is 8 mm, the projecting length is, for example, about 0.5 mm.

The same applies to the second substrate 10b. That is, as illustrated in FIG. 2, the endmost second LED array unit 11b is preferably mounted on the second substrate 10b so that one end (or end portion including the end surface 11ba) of the endmost second LED array unit 11b in the X axis direction projects (in the −X direction in FIG. 2) from one end (specifically, the end surface 10ba of the end portion on the first substrate 10a side) of the second substrate 10b in the X axis direction. However, only one of the endmost first LED array unit 11a and endmost second LED array unit 11b may project from the end in the X axis direction of the corresponding substrate. Also in this case, it is possible to arrange the first substrate 10a and second substrate 10b so that the distance X1 is equal to the spacing X0, while preventing the end surfaces 10aa and 10ba from coming into contact with each other (or spacing the end surfaces 10aa and 10ba from each other).

As illustrated in FIG. 2, in the exposure device 1, the position of the first LED array units 11a in the Y axis direction is different from the position of the second LED array units 11b in the Y axis direction. In the exposure device 1, the first LED array units 11a and second LED array units 11b are not aligned in a straight line, and the position of the LEDs 12a in the Y axis direction is spaced a distance Y1 from the position of the LEDs 12b in the Y axis direction. This is to prevent the end of the endmost first LED array unit 11a on the end surface 11aa side and the end of the endmost second LED array unit 11b on the end surface 11ba side from coming into contact with each other, and facilitate adjustment of the distance X1. The first lens array 20a and second lens array 20b are also not aligned in a straight line, and are held by the holder so that the position of the lenses of the first lens array 20a in the Y axis direction is spaced the distance Y1 from the position of the lenses of the second lens array 20b in the Y axis direction.

Next, the holder will be described in detail by taking as an example the holder 43 including the base 40, lens holder 41, and cover 42. The base 40 may be made of metal, such as aluminum, having high thermal conductivity, and may be formed by extrusion, for example.

The base 40 has a flat surface (or mounting surface) on which the first substrate 10a and second substrate 10b are mounted. The first substrate 10a with the first LED array units 11a and the second substrate 10b with the second LED array units 11b are positioned and mounted on the mounting surface of the base 40 so that the distance X1 in the X axis direction between the center of the LED 12aa and the center of the LED 12ba is equal to the spacing X0 as described above or the difference between the distance X1 and the spacing X0 is within a predetermined range.

For example, when the exposure device 1 is used in an image forming apparatus having a function of printing at a resolution of 600 dpi, the LEDs 12a and 12b need to be arranged in the X axis direction at intervals of 42.3 μm. Thus, the first substrate 10a and second substrate 10b are mounted on the surface (mounting surface) of the base 40 so that the distance X1 is within a range of, for example, 42.3±6 μm.

The first substrate 10a and second substrate 10b are positioned in the Y axis direction as follows, for example. First, in the lens holder 41 with the first lens array 20a and second lens array 20b mounted thereon, the distance in the Y axis direction between the center of the lenses of the first lens array 20a and the center of the lenses of the second lens array 20b is measured. The measured distance is, for example, 3.8 mm. The first substrate 10a and second substrate 10b are positioned in the Y axis direction so that the distance Y1 in the Y axis direction between the center of the LEDs 12a and the center of the LEDs 12b is equal to the measured distance between the lens centers, or the difference between the distance Y1 and the measured distance is within a predetermined range (e.g., the distance Y1 is within a range of 3.8 mm±10 μm), and are mounted on the mounting surface of the base 40.

For such positioning and mounting of the first substrate 10a and second substrate 10b, multiple holes (or positioning holes) for positioning are formed in the first substrate 10a and second substrate 10b, and multiple threaded holes are formed in the mounting surface of the base 40 at positions corresponding to the positioning holes. The first substrate 10a and second substrate 10b are not directly mounted on the mounting surface of the base 40. For example, an insulating sheet 40a formed from a resin film made of polyethylene terephthalate (PET) or the like is mounted on the mounting surface, and then the first substrate 10a and second substrate 10b are mounted on the insulating sheet 40a. The insulating sheet 40a is disposed between the base 40 and the first and second substrates 10a and 10b in order to prevent an electrical short between the base 40 and the first and second substrates 10a and 10b. The insulating sheet 40a has multiple holes formed therein at positions corresponding to the multiple positioning holes.

The lens holder 41 may be made of metal, such as aluminum, having high thermal conductivity, and may be formed by extrusion, for example. Each of the first lens array 20a and second lens array 20b is fixed to the lens holder 41 at an optimum position by adhesive. The optimum position of the first lens array 20a is a position at which a distance Li is equal to a distance Lo. The distance Li is a distance from surfaces of the first LED array units 11a (specifically, light emitting surfaces of the LEDs 12a) to a light incident end surface of the first lens array 20a. The distance Lo is a distance from a light emitting end surface of the first lens array 20a to positions (or focal positions) of imaging points at which images are imaged. The same applies to the optimum position of the second lens array 20b. That is, the optimum position of the second lens array 20b is a position at which a distance Li is equal to a distance Lo. The distance Li is a distance from surfaces of the second LED array units 11b (specifically, light emitting surfaces of the LEDs 12b) to a light incident end surface of the second lens array 20b. The distance Lo is a distance from a light emitting end surface of the second lens array 20b to positions (or focal positions) of imaging points at which images are imaged. In this manner, the first lens array 20a and second lens array 20b are each positioned in the lens holder 41 so that the distance Li is equal to the distance Lo, and are fixed to the lens holder 41 by adhesive, thereby being held by the lens holder 41.

When the first lens array 20a and second lens array 20b are arranged as illustrated in FIG. 1, in order to make a distance L1 equal to a distance L2, the first lens array 20a and second lens array 20b have the same total conjugate length (TC), or TCs whose difference is within a predetermined range. The distance L1 is a distance from the positions at which light is emitted from the LEDs 12a to positions at which the light emitted from the LEDs 12a is imaged. The distance L2 is a distance from the positions at which light is emitted from the LEDs 12b to positions at which the light emitted from the LEDs 12b is imaged.

The lens holder 41 has multiple through-holes formed therein at positions corresponding to parts of the positioning holes formed in the first substrate 10a and parts of the positioning holes formed in the second substrate 10b.

The lens holder 41 is positioned on the base 40 so that optical axes of the first LED array units 11a and first lens array 20a and optical axes of the second LED array units 11b and second lens array 20b are positioned at their optimum positions (in the Y axis direction), and is fixed to the base 40. For example, while the light emitting positions of the LEDs 12a and 12b, the position of the first lens array 20a, and the position of the second lens array 20b are observed by a charge-coupled device (CCD) camera, the position of the lens holder 41 is adjusted so that the light emitting positions of the LEDs 12a coincide with the center of the first lens array 20a in the Y axis direction and the light emitting positions of the LEDs 12b coincide with the center of the second lens array 20b in the Y axis direction. After such positioning, the lens holder 41 is fixed to the base 40 by screws 44. The screws 44 are fixed with the insulating sheet 40a, first substrate 10a, and second substrate 10b between the lens holder 41 and the base 40. For example, such positioning is possible when the positioning holes of the first substrate 10a and second substrate 10b are larger than the diameters of the screws 44.

The first substrate 10a has a region (or contact region) where the lens holder 41 abuts and presses the first substrate 10a. As illustrated in FIG. 2, the contact region is, for example, a region 13aa located at one end of the first substrate 10a in the Y axis direction and located a predetermined distance away from the end near the boundary in the X axis direction of the first substrate 10a in the X axis direction. The second substrate 10b has a region (or contact region) where the lens holder 41 abuts and presses the second substrate 10b. As illustrated in FIG. 2, the contact region is, for example, a region 13ba located at one end of the second substrate 10b in the Y axis direction and located a predetermined distance away from the end near the boundary in the X axis direction of the second substrate 10b in the X axis direction. That is, a surface of the lens holder 41 on the base 40 side is formed to abut against the region 13aa of the first substrate 10a and the region 13ba of the second substrate 10b. The first substrate 10a also has a region (or contact region) where the first substrate 10a abuts against the cover 42 directly or via another member. The contact region is, for example, the region 13ab illustrated in FIG. 2. The second substrate 10b also has a region (or contact region) where the second substrate 10b abuts against the cover 42 directly or via another member. The contact region is, for example, the region 13bb illustrated in FIG. 2.

In this manner, the first substrate 10a and second substrate 10b are fixed to the base 40 while pressed against the mounting surface of the base 40 via the insulating sheet 40a at the regions 13aa, 13ba, 13ab, and 13bb. Thus, in the first substrate 10a, the regions 13aa and 13ab serve as a fixed end and the end surface 10aa as an end serves as a free end; in the second substrate 10b, the regions 13ba and 13bb serve as a fixed end and the end face 10ba as an end serves as a free end. The contact regions of the first substrate 10a and second substrate 10b with the lens holder 41 and cover 42 are not limited to the regions 13aa, 13ba, 13ab, and 13bb illustrated in FIG. 2, and may be any regions that do not interfere with adjustment by first and second adjustment mechanisms described later. For example, each of the contact regions in the first substrate 10a may be the entire region of an end of the first substrate 10a in the Y axis direction except for an end of the first substrate 10a on the second substrate 10b side in the X axis direction (i.e., the end near the boundary). The same applies to the contact regions of the second substrate 10b.

The cover 42 is a covering member that covers a part of the base 40 and the like for purposes, such as, preventing foreign matter from adhering to the first substrate 10a, second substrate 10b, and the like, and preventing external light from being incident on the incident surfaces of the first lens array 20a and second lens array 20b. In FIG. 1, the cover 42 is mounted on the base 40 by screws 45, 46, and 47. Gaps between the cover 42 and the first and second lens arrays 20a and 20b are filled with sealing material 48, such as silicon resin, which prevents foreign material from entering the inside of the exposure device 1. When there are other gaps at other positions, the other gaps are also filled with sealing material.

As illustrated in FIG. 1, the exposure device 1 may include an interface board 30. The interface board 30 is a board on which a circuit is mounted. The circuit receives control signals sent from a controller (not illustrated) of an image forming apparatus to which the exposure device 1 is mounted, and sends the control signals to the first substrate 10a and second substrate 10b to cause the LEDs 12a (including the LED 12aa) and the LEDs 12b (including the LED 12ba) to emit light. The circuit may include a connector 32 for connection to the controller, and other electronic components 33, such as a resistor, a capacitor, or an interface integrated circuit (IC). As illustrated in FIG. 1, for example, the interface board 30 is inserted and positioned in a positioning concave portion (or guide portion) formed in a side of the base 40, and then is fixed to the base 40 by a screw 49. The cover 42 also serves as a protection for electronic components mounted on the interface board 30.

Next, the main features of the exposure device 1 according to the first embodiment will be described.

The exposure device 1 includes a first adjustment mechanism that adjusts a first distance in the Z axis direction between the first lens array 20a and the first LED array units 11a (or LEDs 12a). The first adjustment mechanism is provided in the holder. The first distance is a distance in the Z axis direction, that is, a distance in a direction perpendicular to the surface (referred to as the main surface) of the first substrate 10a on which the first LED array units 11a are mounted. By adjusting the first distance by the first adjustment mechanism, it is possible to adjust a distance between a position at which light exits the first lens array 20a and a position at which the light is imaged, that is, the distance Lo. In particular, the first distance is a distance between the first lens array 20a and the light emitting surfaces of the LEDs 12a, and the first adjustment mechanism adjusts at least the distance between the first lens array 20a and the light emitting surface of the LED 12aa, which is closest to the end surface 11aa of the endmost first LED array unit 11a illustrated in FIG. 2.

The exposure device 1 may also include a second adjustment mechanism that adjusts a second distance in the Z axis direction between the second lens array 20b and the second LED array units 11b (or LEDs 12b). Like the first distance, the second distance is a distance in the Z axis direction. In particular, the second distance is a distance between the second lens array 20b and the light emitting surfaces of the LEDs 12b, and the second adjustment mechanism adjusts at least the distance between the second lens array 20b and the light emitting surface of the LED 12ba, which is closest to the end surface 11ba of the endmost second LED array unit 11b illustrated in FIG. 2. Like the first adjustment mechanism, the second adjustment mechanism is also provided in the holder. By adjusting the second distance by the second adjustment mechanism, it is possible to adjust a distance between a position at which light exits the second lens array 20b and a position at which the light is imaged.

The first and second adjustment mechanisms will be described below by taking, as an example, mechanisms that adjust the positions of the first substrate 10a and the second substrate 10b in the Z axis direction, with the first lens array 20a and second lens array 20b fixed.

However, the first adjustment mechanism may be a mechanism that adjusts the position of the first lens array 20a in the Z axis direction. For example, the first adjustment mechanism, which in this case may be provided in the lens holder 41, may be a mechanism that moves up and down the first lens array 20a, or a mechanism, such as a screw mechanism or a cam mechanism, that presses and bends the end of the first lens array 20a near the boundary between the first lens array 20a and the second lens array 20b. Likewise, the second adjustment mechanism may be a mechanism that adjusts the position of the second lens array 20b in the Z axis direction. For example, the second adjustment mechanism, which in this case may be provided in the lens holder 41, may be a mechanism that moves up and down the second lens array 20b, or a mechanism, such as a screw mechanism or a cam mechanism, that presses and bends the end of the second lens array 20b near the boundary between the first lens array 20a and the second lens array 20b. The first adjustment mechanism may be a mechanism that adjusts the position of the first substrate 10a in the Z axis direction and the position of the first lens array 20a in the Z axis direction. The second adjustment mechanism may be a mechanism that adjusts the position of the second substrate 10b in the Z axis direction and the position of the second lens array 20b in the Z axis direction.

The first adjustment mechanism may be a mechanism that displaces an end in the X axis direction of the first substrate 10a in at least one of a direction toward the first lens array 20a and a direction away from the first lens array 20a. Likewise, the second adjustment mechanism may be a mechanism that displaces an end in the X axis direction of the second substrate 10b in at least one of a direction toward the second lens array 20b and a direction away from the second lens array 20b.

The first adjustment mechanism may include a first screw mechanism 50a that adjusts the first distance. As illustrated in FIGS. 1 and 3, the first screw mechanism 50a may include, for example, a threaded hole 51a formed in the base 40 and an adjustment screw 52a that is screwed into the threaded hole 51a. The threaded hole 51a is a hole bored through the base 40 in a direction (or the Z axis direction) perpendicular to the mounting surface of the base 40 and opening at the mounting surface. The screw 52a may be a set screw, a stop screw, or the like. The screw 52a and threaded hole 51a are configured so that a tip of the screw 52a can abut against a surface (or back surface) of the first substrate 10a opposite to the main surface in the −Z direction (or the direction toward the minus side of the Z axis) by inserting the screw 52a into the threaded hole 51a and advancing the screw 52a in the Z axis direction. The region where the screw 52a abuts against the first substrate 10a is, for example, the region 14a illustrated in FIG. 2. By rotating the screw 52a to change the position of the screw 52a, it is possible to adjust the distance (i.e., the first distance) between the first lens array 20a and the first substrate 10a. Since the first adjustment mechanism is a mechanism for adjusting the distance near the boundary between the second substrate 10b and the first substrate 10a, the region where the screw 52a abuts against the first substrate 10a includes an end of the first substrate 10a on the second substrate 10b side, as exemplarily illustrated by the region 14a in FIG. 2. As illustrated in FIGS. 1 and 3, to insert a tool, such as a hexagon wrench or a screwdriver, for rotating the screw 52a, a through hole 54a is formed in the base 40 at a position corresponding to the screw 52a.

The second adjustment mechanism may include a second screw mechanism 50b that adjusts the second distance. The second adjustment mechanism 50b may be similar to the first screw mechanism 50a. As illustrated in FIG. 3, the second screw mechanism 50b may include, for example, a threaded hole 51b formed in the base 40 and a screw 52b that is screwed into the threaded hole 51b. The screw 52b may be configured, for example, so that a tip of the screw 52b abuts against the region 14b illustrated in FIG. 2. As illustrated in FIG. 3, to insert a tool, such as a hexagon wrench or a screwdriver, for rotating the screw 52b, a through hole 54b is formed in the base 40 at a position corresponding to the screw 52b. The position of the region 14b in the Y axis direction is preferably the same as the position of the region 14a in the Y axis direction, but may be different therefrom.

The holder, an example of which is the holder 43, preferably has a space that allows at least one of displacement of the end in the X axis direction of the first substrate 10a toward the first lens array 20a and displacement of the end in the X axis direction of the first substrate 10a away from the first lens array 20a. The space is a space for adjustment by the first adjustment mechanism.

The holder, an example of which is the holder 43, also preferably has a space that allows at least one of displacement of the end in the X axis direction of the second substrate 10b toward the second lens array 20b and displacement of the end in the X axis direction of the second substrate 10b away from the second lens array 20b. The space is a space for adjustment by the second adjustment mechanism.

For example, as illustrated in FIG. 3, the lens holder 41, which presses the first substrate 10a and second substrate 10b, has steps having a height Z1 (e.g., about 1 mm) at positions corresponding to the ends in the X axis direction of the first substrate 10a and second substrate 10b near the boundary therebetween. The steps may be cut steps formed by cutting. A space formed by the cut steps will be referred to below as the cut step portion 41a. Such a structure allows the end of the first substrate 10a on the second substrate 10b side in the X axis direction to be displaced toward the first lens array 20a (or in the −Z direction) and allows the end of the second substrate 10b on the first substrate 10a side in the X axis direction to be displaced toward the second lens array 20b (or in the −Z direction). Although the photosensitive drum 113 and screw 47 are not illustrated in FIG. 3, the screw 47 may be provided near the boundary between the first substrate 10a and the second substrate 10b.

An adjustment operation using the first and second adjustment mechanisms will be described.

An adjuster connects the controller of the image forming apparatus or an adjustment circuit as a substitute for the controller to the connector 32 illustrated in FIG. 1, and causes the controller or the adjustment circuit to send control signals to the first substrate 10a and second substrate 10b via the interface board 30. By receiving the control signals, the first substrate 10a and second substrate 10b supplies electrical current to the first LED array units 11a and second LED array units 11b, thereby causing the LEDs 12a and 12b to emit light. In the state where the LEDs 12a and 12b emit light, the adjuster adjusts at least one of the first distance and second distance while observing the positions of the imaging points of the light emitted from the first lens array 20a and second lens array 20b by means of a CCD camera.

More specifically, the adjuster observes at least the positions of the imaging points of the light emitted from the LEDs 12aa and 12ba (i.e., imaging positions of the LEDs 12aa and 12ba), compares the positions, and adjusts at least one of the first and second distances so that the positions coincide with each other in the Z axis direction. As described above, the region 14a illustrated in FIG. 2 is the region where the screw 52a abuts against the back surface of the first substrate 10a, which is the surface opposite to the surface on which the first LED array units 11a are mounted. The regions 13aa and 13ab are the regions where the lens holder 41 and cover 42 abut (or press) against the first substrate 10a. Likewise, the region 14b is the region where the screw 52b abuts against the back surface of the second substrate 10b, and the regions 13ba and 13bb are the regions where the lens holder 41 and cover 42 abut against the second substrate 10b. When the position in the Z axis direction of the imaging points of one of the first substrate 10a and second substrate 10b is farther from the lens (or higher) than that of the other, the adjuster can bend the one substrate in the −Z direction with the regions 13aa and 13ab or the regions 13ba and 13bb as a fulcrum by advancing in the −Z direction one of the screws 52a and 52b corresponding to the one substrate, thereby decreasing the distance Li. Thereby, it is possible to decrease the distance Lo, that is, to lower the position in the Z axis direction of the imaging points. In this manner, while observing the images of the LEDs 12aa and 12ba, the adjuster performs the adjustment so that the positions in the Z axis direction of the imaging points of light emitted from the LEDs 12aa and 12ba coincide with each other.

After the adjustment, the screws 52a and 52b are fixed by applying adhesive, such as anaerobic adhesive, for preventing screw loosening to the threaded holes 51a and 51b. It is also possible to apply the adhesive to the threaded holes 51a and 51b, insert the screws 52a and 52b into the threaded holes 51a and 51b with the adhesive applied thereto, and perform the adjustment before the adhesive solidifies. The through holes 54a and 54b are preferably filled with sealing material, such as silicon resin. It is also preferable to, after completion of the adjustment and the fixation of the screws 52a and 52b, fill the cut step portion 41a, which is a cavity portion, with sealing material, such as silicon resin, thereby preventing foreign matter from entering the inside of the exposure device 1.

As above, by providing the cut step portion 41a in the lens holder 41, forming the threaded holes 51a and 51b in the base 40, and pressing at least one of the ends of the first substrate 10a and second substrate 10b near the boundary by the screws 52a and 52b in the −Z direction, it is possible to change the position of the imaging point of at least one of the LEDs 12aa and 12ba. As a result, it is possible to eliminate or reduce the difference between the positions in the Z axis direction of imaging points of the first substrate 10a and second substrate 10b near the boundary, thereby eliminating or reducing uneven print density due to the difference between spot diameters of light illuminating the photosensitive drum 113 near the boundary. By adjustment by at least one of the first and second adjustment mechanisms, it is also possible to compensate the difference in TC between the first lens array 20a and the second lens array 20b.

The first adjustment mechanism adjusts the position of the first substrate 10a in the Z axis direction near the boundary, and the second adjustment mechanism adjusts the position of the second substrate 10b in the Z axis direction near the boundary. Thus, the ends of the substrates near the boundary including the abutment regions for adjustment (e.g., the regions 14a and 14b against which the screws 52a and 52b abut) are free ends. When the ends of the first substrate 10a and second substrate 10b near the boundary are displaced in the Z axis direction with the ends as free ends and with the regions 13aa, 13ab, 13ba, and 13bb as a fulcrum, in each of the first substrate 10a and second substrate 10b, the distance to the imaging point of light passing through the lens varies with position in the X axis direction. However, in each of the first substrate 10a and second substrate 10b, the distance varies gradually due to deflection of the substrate, and does not vary sharply. Thus, no visible unevenness in print density occurs.

A part around the boundary between the first substrate 10a and second substrate 10b has been described above. Next, the end (referred to as the other end) in the X axis direction of the first substrate 10a opposite to the end on the second substrate 10b side, and the end (referred to as the other end) in the X axis direction of the second substrate 10b opposite to the end on the first substrate 10a side will be briefly described.

The other ends in the X axis direction of the first substrate 10a and second substrate 10b may be provided with no adjustment mechanism and pressed by the lens holder 41 to be fixed to the base 40 via the insulating sheet 40a, like the central parts of the first substrate 10a and second substrate 10b in the X axis direction, for example. When another LED unit substrate, which is similar to the first substrate 10a, with LED array units and another lens array are provided in the exposure device 1 so that the other substrate is arranged adjacent to the other end of one of the first substrate 10a and second substrate 10b, the holder may further include an adjustment mechanism corresponding to the other end adjacent to the other substrate. This will be described by taking as an example a case where the other substrate is arranged adjacent to the other end of the first substrate 10a. In this case, the other end may be formed to have the same shape as the end near the boundary with the second substrate 10b, and the holder may further include, for the other end, an adjustment mechanism similar to the first adjustment mechanism.

Further, the first embodiment is not limited to the above-described example, and can be used or varied in various ways. For example, the first adjustment mechanism and second adjustment mechanism are not limited to mechanisms that adjust the positions of the imaging points in the Z axis direction by pressing the ends (in the X axis direction) of the first substrate 10a and second substrate 10b near the boundary, and may be mechanisms that adjust the positions of the imaging points in the Z axis direction by pressing central parts of the first substrate 10a and second substrate 10b in the X axis direction as well as the ends. In this case, instead of the arrangement of the lens holder 41 and the first and second substrates 10a and 10b as illustrated in FIG. 1, the following configuration may be employed, for example. The lens holder is configured so as not to interfere with displacement of the first substrate 10a and second substrate 10b in the Z axis direction; the first adjustment mechanism and second adjustment mechanism are configured to independently adjust the first distance and second distance by independently moving up and down the entire first substrate 10a and the entire second substrate 10b on the base.

In the above-described example, the exposure device 1 includes the first adjustment mechanism and second adjustment mechanism. However, the exposure device 1 may include one of the first adjustment mechanism and second adjustment mechanism. Even in this case, it is possible to adjust one of the first distance and second distance, thereby obtaining advantages as described above.

In the above-described example, the LEDs (or first light emitting elements) 12a are arranged on the first substrate 10a, and the LEDs (or second light emitting elements) 12b are arranged on the second substrate 10b. However, the LEDs 12a and 12b may be arranged on the same substrate. In this case, the first adjustment mechanism may be a mechanism that adjusts the position of the first lens array 20a, and the second adjustment mechanism may be a mechanism that adjusts the position of the second lens array 20b. One of the first and second adjustment mechanisms may be omitted.

In the exposure device according to the first embodiment, an optical unit including the second LED array units 11b, second substrate 10b, and second lens array 20b is not necessarily required. The exposure device according to the first embodiment may be a device (referred to below as a unitary device) including one or more first LED array units 11a, first substrate 10a, first lens array 20a, and a part of the holder 43 that holds these components. For example, an exposure device having the above-described advantages can be configured by arranging multiple unitary devices in the X axis direction and connecting their holders to each other. In this case, adjacent unitary devices need to be connected to each other so that their LEDs are equally spaced at the boundary portion between the adjacent unitary devices. Thus, in each of the adjacent unitary devices, the end of the holder connected to the other unitary device needs to be formed to open in the X axis direction. A unitary device described above may be connected to another exposure device including LED array units, an LED array substrate, and a lens array that are the same as those of the unitary device but including no adjustment mechanism. In the resultant exposure device obtained by connecting the unitary device to the other exposure device, it is possible to adjust, on the unitary device side, the positions in the Z axis direction of imaging points at the end of the unitary device on the other exposure device side so that they coincide with the positions in the Z axis direction of imaging points at the end of the other exposure device on the unitary device side, thereby obtaining the same advantages.

In the above examples, the number of LED unit substrates is equal to the number of lens arrays. However, when the first distance is adjusted by adjusting the position of the LED unit substrate by, for example, the first screw mechanism 50a illustrated in FIG. 1, one lens array may be provided to multiple LED unit substrates. On the other hand, when the first distance is adjusted by adjusting the position of the lens array, one LED unit substrate may be provided to multiple lens arrays.

As described above, the exposure device 1 according to the first embodiment includes a mechanism for adjusting the distance between an LED array unit and a lens array. Thus, when the LED array unit substrate with the LED array unit and the lens array are arranged adjacent to another LED unit substrate with another LED array unit and another lens array, it is possible to easily perform adjustment to eliminate or reduce the difference between the positions in the Z axis direction of imaging points of light emitted from the LED array units and passing through the lens arrays, around the boundary. Further, according to the first embodiment, it is possible to provide a long exposure device by arranging short LED unit substrates and lens arrays, which are low in cost, and configure the adjustment mechanism with a simple structure, thereby providing an exposure device at low cost.

### Second Embodiment

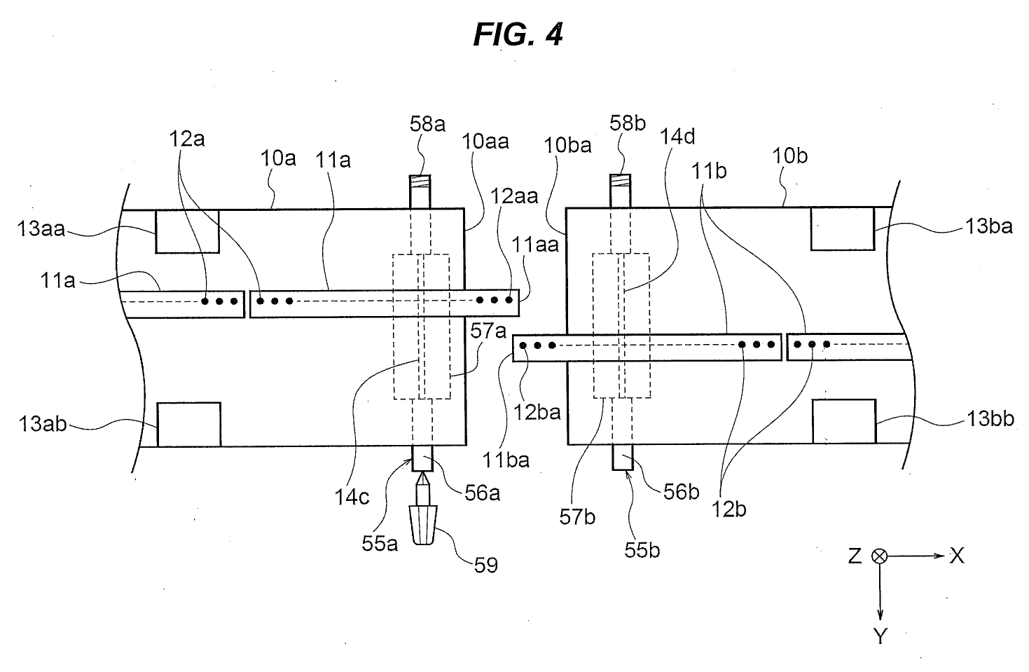

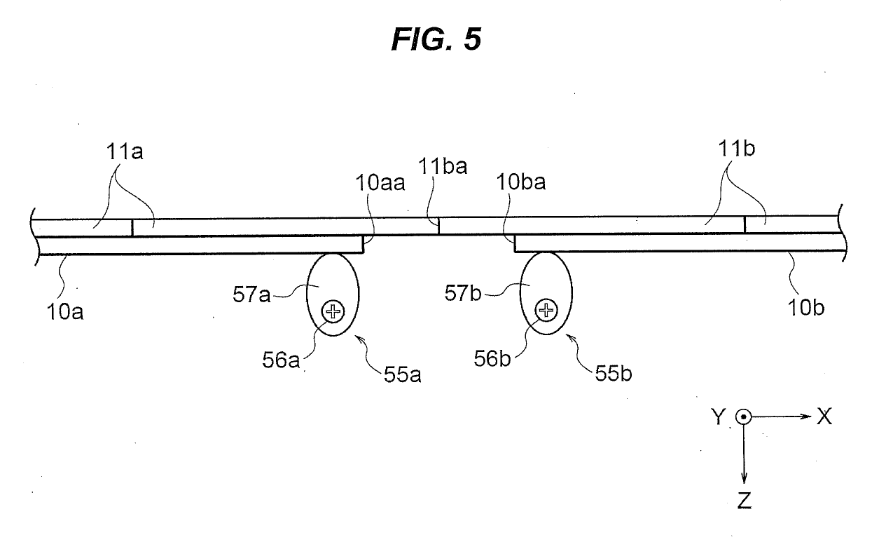

FIG. 4 is a top view schematically illustrating an example of LED unit substrates and adjustment mechanisms of an exposure device according to the second embodiment. FIG. 5 is a view of the LED unit substrates and adjustment mechanisms in FIG. 4 as viewed in the −Y direction. FIGS. 4 and 5 each illustrate a part around a boundary between the LED unit substrates. In FIGS. 4 and 5, elements that are the same as or correspond to those in FIGS. 1 to 3 are indicated by the same reference characters. In FIG. 5, the LEDs 12a and 12b are not illustrated.

The exposure device according to the second embodiment differs from the exposure device 1 according to the first embodiment in that it includes a first cam mechanism 55a as the first adjustment mechanism instead of the first screw mechanism and a second cam mechanism 55b as the second adjustment mechanism instead of the second screw mechanism. The second embodiment will be described below focusing on differences from the first embodiment. Various examples described in the first embodiment can be applied to the second embodiment.

The first cam mechanism 55a adjusts the first distance. As illustrated in FIGS. 4 and 5, for example, the first cam mechanism 55a includes a first cam 57a, such as an eccentric cam, and adjusts the first distance by changing the rotational position of the first cam 57a while the first cam 57a abuts in the −Z direction against a region 14c in the back surface of the first substrate 10a.

As described above, the first distance is a distance in the Z axis direction between the first lens array 20a and the first substrate 10a (in particular, the light emitting surface of the LED 12aa on the endmost first LED array unit 11a). As illustrated in FIGS. 4 and 5, a rotary shaft 56a is fixed to the first cam 57a, and a recess (a cross-shaped recess in the example of FIG. 5) for rotating the first cam 57a with a screwdriver 59 is formed in the rotary shaft 56a. For example, a thread groove 58a is formed at an end of the rotary shaft 56a opposite to the end with the recess. The thread groove 58a is screwed into a hole formed in an inner wall of the base 40 illustrated in FIG. 1.

With this configuration, an adjuster can change the rotational position of the first cam 57a from the Y axis direction by using the screwdriver 59 corresponding to the shape of the recess of the rotary shaft 56a. For example, in the base, which is a part of the holder of the second embodiment, spaces accommodating the first cam mechanism 55a including the first cam 57a and the second cam mechanism 55b including a second cam 57b described later are formed in the mounting surface of the first substrate 10a and second substrate 10b. Further, a through hole corresponding to the through hole 54a in the base 40 illustrated in FIG. 1 is formed in the base at a position corresponding to the first cam 57a so as to allow insertion of the screwdriver 59. After adjustment of the first distance, it is preferable to fix the opposite end of the rotary shaft 56a in the hole formed in the inner wall with adhesive and fill the through hole corresponding to the through hole 54a with sealing material, such as silicon resin.

The second cam mechanism 55b adjusts the second distance. The second cam mechanism 55b may have the same configuration as the first cam mechanism 55a, and detailed description thereof will be omitted. In FIGS. 4 and 5, the second cam mechanism 55b includes the second cam 57b rotatable about a rotary shaft 56b, and adjusts the second distance by changing the rotational position of the second cam 57b while the second cam 57b abuts in the −Z direction against a region 14d in the back surface of the second substrate 10b. In FIG. 4, the rotary shaft 56b has a thread groove 58b corresponding to the thread groove 58a.

The configurations of the first cam mechanism 55a and second cam mechanism 55b, including the shapes of the first cam 57a and second cam 57b, are not limited to those described above. The holder of the exposure device of the second embodiment may, for example, include the first cam mechanism 55a as the first adjustment mechanism and the second screw mechanism 50b illustrated in FIG. 3 as the second adjustment mechanism.

The second embodiment can achieve the same advantages as the first embodiment by the adjustment mechanisms having the cam mechanisms. In addition, the second embodiment makes it easy to employ a structure in which an LED unit substrate can be adjusted from below in FIG. 4, thereby facilitating the adjustment.

### Third Embodiment

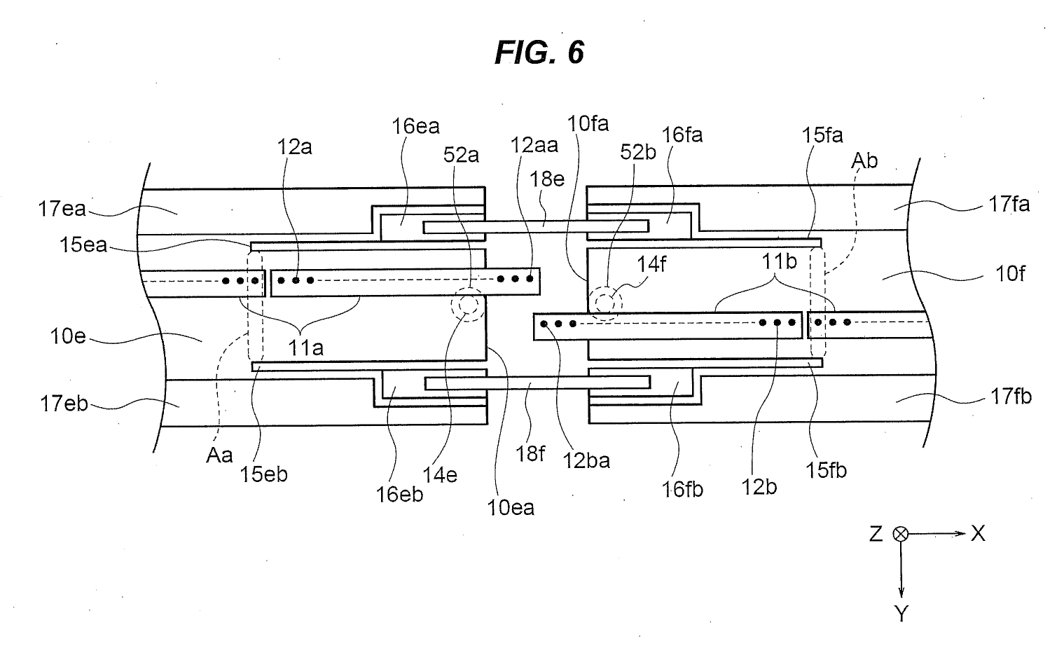

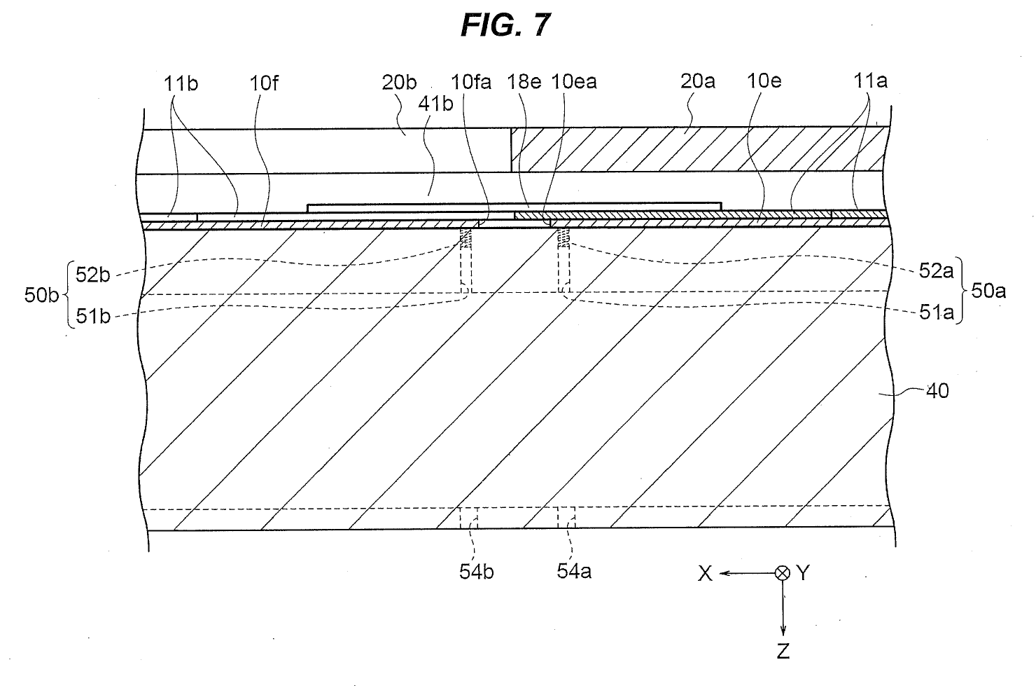

FIG. 6 is a top view schematically illustrating an example of LED unit substrates in an exposure device according to a third embodiment. FIG. 7 is a sectional view (corresponding to the sectional view of FIG. 3) of the exposure device. FIGS. 6 and 7 each illustrate a part around a boundary between the LED unit substrates. In FIGS. 6 and 7, elements that are the same as or correspond to those in FIGS. 1 to 5 are indicated by the same reference characters.

The exposure device according to the third embodiment differs from the exposure device 1 according to the first embodiment or the exposure device according to the second embodiment in that at least one of the first substrate and second substrate has a notched portion (or slit). The third embodiment will be described below focusing on differences from the first embodiment. Various examples described in the first and second embodiments can be applied to the third embodiment.

In FIG. 6, a first substrate 10e, which corresponds to the first substrate 10a illustrated in FIG. 3, has first notched portions (or first slits) 15ea and 15eb extending along the first LED array units 11a from an end (or end surface 10ea) in the X axis direction of the first substrate 10e. In this example, the two first slits 15ea and 15eb are formed in the first substrate 10e on both sides of the first LED array units 11a. However, the number of first slits formed in the first substrate 10e may be one, three, or more. The first slits 15ea and 15eb illustrated in FIG. 6 are formed parallel to the X axis. However, the first slits need not necessarily be formed parallel to the X axis, and it is sufficient that they be formed to extend along the first LED array units 11a.

As illustrated in FIG. 6, a second substrate 10f, which corresponds to the second substrate 10b illustrated in FIG. 3, has second notched portions (or second slits) 15fa and 15fb extending along the second LED array units 11b from an end (or end surface 10fa) in the X axis direction of the second substrate 10f. The second slits 15fa and 15fb may be formed in the same manner as the first slits 15ea and 15eb.

The holder of the exposure device according to the third embodiment includes, for example, a base, a lens holder, and a cover. The first slits 15ea and 15eb allow the lens holder and cover to abut against the first substrate 10e in contact regions whose shapes are different from the contact regions where the lens holder 41 and cover 42 in FIG. 1 abut against the first substrate 10a, and allow the area of the contact regions where the lens holder and cover abut against the first substrate 10e to be larger than the area of the contact regions where the lens holder 41 and cover 42 in FIG. 1 abut against the first substrate 10a. Likewise, the second slits 15fa and 15fb allow the lens holder and cover to abut against the second substrate 10f in contact regions whose shapes are different from the contact regions where the lens holder 41 and cover 42 in FIG. 1 abut against the second substrate 10b, and allow the area of the contact regions where the lens holder and cover abut against the second substrate 10f to be larger than the area of the contact regions where the lens holder 41 and cover 42 in FIG. 1 abut against the second substrate 10b.

This will be specifically described below. The regions 17ea and 17eb illustrated in FIG. 6 correspond to the regions 13aa and 13ab illustrated in FIG. 2, and are regions where the lens holder and cover abut against the first substrate 10e. Specifically, the first substrate 10e abuts against the lens holder (lens holder 41b illustrated in FIG. 7) corresponding to the lens holder 41 illustrated in FIG. 1 and the cover corresponding to the cover 42 illustrated in FIG. 1 in the regions 17ea and 17eb illustrated in FIG. 6, and is fixed to the base 40 illustrated in FIG. 7 while pressed by (or being in pressure contact with) the lens holder 41b and cover. Likewise, the regions 17fa and 17fb illustrated in FIG. 6 correspond to the regions 13ba and 13bb illustrated in FIG. 2, and are regions where the lens holder 41b and cover abut against the second substrate 10f.

The region 14e illustrated in FIG. 6 corresponds to the region 14a illustrated in FIG. 2, and is a region where the screw 52a abuts against the first substrate 10e. The region 14f illustrated in FIG. 6 corresponds to the region 14b illustrated in FIG. 2, and is a region where the screw 52b abuts against the second substrate 10f.

The first distance is adjusted by the first screw mechanism 50a, which is an example of the first adjustment mechanism, illustrated in FIG. 7. The first distance is adjusted by causing the tip of the screw 52a to abut against the region 14e to press the first substrate 10e in the −Z direction. As illustrated in FIG. 6, the first slits 15ea and 15eb are formed in the first substrate 10e. Thus, regardless of whether or not both ends in the Y axis direction of the first substrate 10e are fixed, the end on the second substrate 10f side of the region of the first substrate 10e between the first slits 15ea and 15eb (or the central region in the Y axis direction of the first substrate 10e) is a free end, and can be displaced in the −Z direction by the screw 52a of the first screw mechanism 50a. At this time, the regions Aa and Ab serve as fixed ends.

Thus, even when both ends in the Y axis direction of the end on the second substrate 10f side of the first substrate 10e are pressed and fixed, the first distance can be adjusted. In this case, the straight line connecting a position of the first slit 15ea farthest from the second substrate 10f and a position of the first slit 15eb farthest from the second substrate 10f serve as a fulcrum in the adjustment. Even when a single first slit is formed in the first substrate 10e, although the position of the fulcrum is different from the above, the first distance can be adjusted. For the same reason, both ends of the second substrate 10f in the Y axis direction can also be fixed. Thus, the regions 17ea, 17eb, 17fa, and 17fb illustrated in FIG. 6 include both ends in the Y axis direction of the end near the boundary of each of the first substrate 10e and second substrate 10f. Thus, it is possible to increase the area of the contact regions with the lens holder 41b and cover.

As above, the first slits 15ea and 15eb and the second slits 15fa and 15fb are formed in the first substrate 10e and second substrate 10f. Thus, even when the first substrate 10e and second substrate 10f are pressed by the lens holder 41b, it is possible to move and adjust, in the −Z direction, the central regions in the Y axis direction of the ends of the first substrate 10e and second substrate 10f near the boundary by adjusting displacement in the −Z direction of the screws 52a and 52b with their tips abutting against the regions 14e and 14f.

For the adjustment of the first distance and second distance, the first slits 15ea and 15eb and second slits 15fa and 15fb are formed so as not to overlap the mounting positions of the first LED array units 11a, the mounting positions of the second LED array units 11b, and the regions 14e and 14f (or the regions of the first substrate 10e and second substrate 10f pressed by the first adjustment mechanism and second adjustment mechanism during the adjustment).

After completion of the adjustment, it is preferable to fill a gap formed between the lens holder 41b and the base 40 near the boundary between the first substrate 10e and the second substrate 10f with sealing material, such as silicon resin, thereby preventing foreign material from entering the inside of the exposure device.

Surfaces of LED unit substrates are typically covered with resist. However, the regions 16ea, 16eb, 16fa, and 16fb illustrated in FIG. 6 near the boundary between the first substrate 10e and the second substrate 10f may be non-resist regions where there is no conductor pattern, resist has been removed, and a base material is exposed. As illustrated in FIGS. 6 and 7, it is preferable to fix plate pieces 18e and 18f made of material, such as ceramic, having small thermal contraction to the non-resist regions 16ea, 16eb, 16fa, and 16fb with instant adhesive, thereby preventing the first substrate 10e and second substrate 10b from coming into contact with each other due to heat.

FIGS. 6 and 7 illustrate a part around the boundary between the first substrate 10e and the second substrate 10f. When another LED unit substrate is connected to the other end in the X axis direction of the first substrate 10e or second substrate 10f, it is preferable that the other end be also provided with the first slits 15ea and 15eb and the first adjustment mechanism or the second slits 15fa and 15fb and the second adjustment mechanism.

As described above, according to the third embodiment, in addition to the advantages of the first or second embodiment, it is possible to hold more securely LED unit substrates, e.g., the first substrate 10e and second substrate 10f.

### Fourth Embodiment

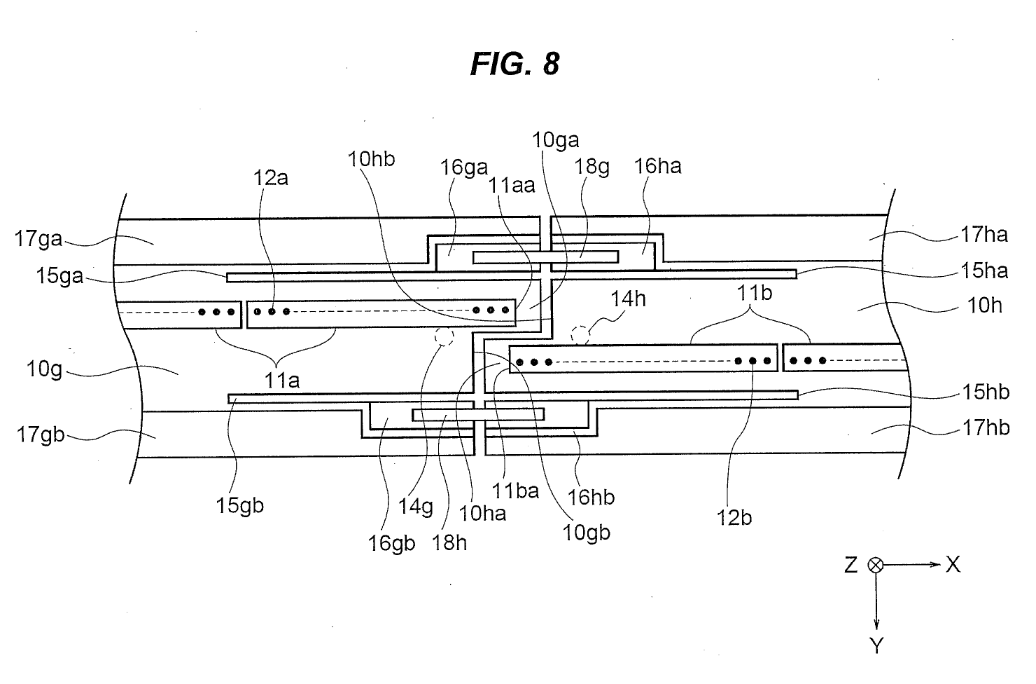

FIG. 8 is a top view schematically illustrating an example of LED unit substrates of an exposure device according to a fourth embodiment. FIG. 8 illustrates a part around a boundary between the LED unit substrates. In FIG. 8, elements that are the same as or correspond to those in FIGS. 1 to 7 are indicated by the same reference characters.

The exposure device according to the fourth embodiment includes a first substrate 10g and a second substrate 10h. The shapes of the first substrate 10g and second substrate 10h near the boundary differ from those in the exposure device according to each of the first to third embodiments. The fourth embodiment will be described below focusing on differences from the third embodiment. Various examples described in the first to third embodiments can be applied to the fourth embodiment.

In the exposure device according to the fourth embodiment, as illustrated in FIG. 8, the first substrate 10g has a first projection 10ga having an end surface facing an end surface 10hb of the second substrate 10h, and the second substrate 10h has a second projection 10ha having an end surface facing an end surface 10gb of the first substrate 10g. With such a configuration, it is possible to prevent the endmost first LED array unit 11a and endmost second LED array unit 11b from coming into contact with each other during positioning of the first substrate 10g and second substrate 10h.

One end (or the end including the end surface 11aa) of the endmost first LED array unit 11a in the X axis direction is mounted on the first projection 10ga. One end (or the end including the end surface 11ba) of the endmost second LED array unit 11b in the X axis direction is mounted on the second projection 10ha. In the fourth embodiment, the holder holds the first substrate 10g and second substrate 10h so that the first projection 10ga at least partially overlaps the second projection 10ha in the X axis direction. The shapes of the first projection 10ga and second projection 10ha are not limited to those illustrated in FIG. 8.

As illustrated in FIG. 8, first notched portions (or first slits) 15ga and 15gb similar to the first slits 15ea and 15eb illustrated in FIG. 6 are formed in the first substrate 10g, and second notched portions (or second slits) 15ha and 15hb similar to the second slits 15fa and 15fb illustrated in FIG. 6 are formed in the second substrate 10h. The lens holder 41b illustrated in FIG. 7 and cover abut against regions 17ga and 17gb in the first substrate 10g, and regions 17ha and 17hb in the second substrate 10h. As illustrated in FIG. 8, the regions 17ga and 17gb include both ends of the first substrate 10g in the Y axis direction near the boundary; the regions 17ha and 17hb include both ends of the second substrate 10h in the Y axis direction near the boundary.

The region 14g illustrated in FIG. 8 is a region where an adjustment screw (corresponding to the screw 52a illustrated in FIG. 7) abuts against the first substrate 10g, like the region 14e illustrated in FIG. 6. The region 14h illustrated in FIG. 8 is a region where an adjustment screw (corresponding to the screw 52b illustrated in FIG. 7) abuts against the second substrate 10h, like the region 14f illustrated in FIG. 6. By adjusting displacement in the −Z direction of the adjustment screws with their tips abutting against the regions 14g and 14h, it is possible to move and adjust, in the −Z direction, the central regions in the Y axis direction of the ends of the first substrate 10g and second substrate 10h near the boundary.

As described above, the end including the end surface 11aa of the endmost first LED array unit 11a is mounted on the first substrate 10g, and the end including the end surface 11ba of the endmost second LED array unit 11b is mounted on the second substrate 10h; the endmost first LED array unit 11a and endmost second LED array unit 11b do not project from the first substrate 10g and second substrate 10h as illustrated in FIGS. 2, 4, and 6 of the first to third embodiments. Thus, the endmost first LED array unit 11a is less likely to be separated from the first substrate 10g, and the endmost second LED array unit 11b is less likely to be separated from the second substrate 10h. According to the fourth embodiment, while preventing the endmost first LED array unit 11a and endmost second LED array unit 11b from coming into contact with each other, it is possible to increase the strength of the connection by the bonding wires in the first substrate 10g and second substrate 10h, compared to the structures illustrated in FIGS. 2, 4, and 6.

Further, the first projection 10ga and second projection 10ha make it possible to reduce the distance between the end surfaces of the first substrate 10g and second substrate 10h near the boundary, thereby allowing the first substrate 10g and second substrate 10h to be securely held by the holder. Further, the gap formed between the lens holder 41b illustrated in FIG. 7 and the base 40 near the boundary is small, leading to reduction in the amount of the sealing material for filling the gap.

Like the non-resist regions 16ea, 16eb, 16fa, and 16fb illustrated in FIG. 6, the regions 16ga, 16gb, 16ha, and 16hb illustrated in FIG. 8 are non-resist regions where a base material is exposed, and regions to which plate pieces 18g and 18h similar to the plate pieces 18e and 18f illustrated in FIG. 6 are fixed.

FIG. 8 illustrates a part around the boundary between the first substrate 10g and the second substrate 10h. When another LED unit substrate is connected to the other end of the first substrate 10g or second substrate 10h in the X axis direction, it is preferable that the other end be also provided with the first projection 10ga and first adjustment mechanism or the second projection 10ha and second adjustment mechanism.

In the example of FIG. 8, the first projection 10ga and second projection 10ha are formed. However, it is also possible that only one of the first and second substrates has the projection, and the other is configured so that the end of the LED array unit projects as illustrated in FIG. 6.

As described above, according to the fourth embodiment, in addition to the advantages of the first to third embodiments, it is possible to increase the strength of the connection by the bonding wires on the LED unit substrates.

### Fifth Embodiment

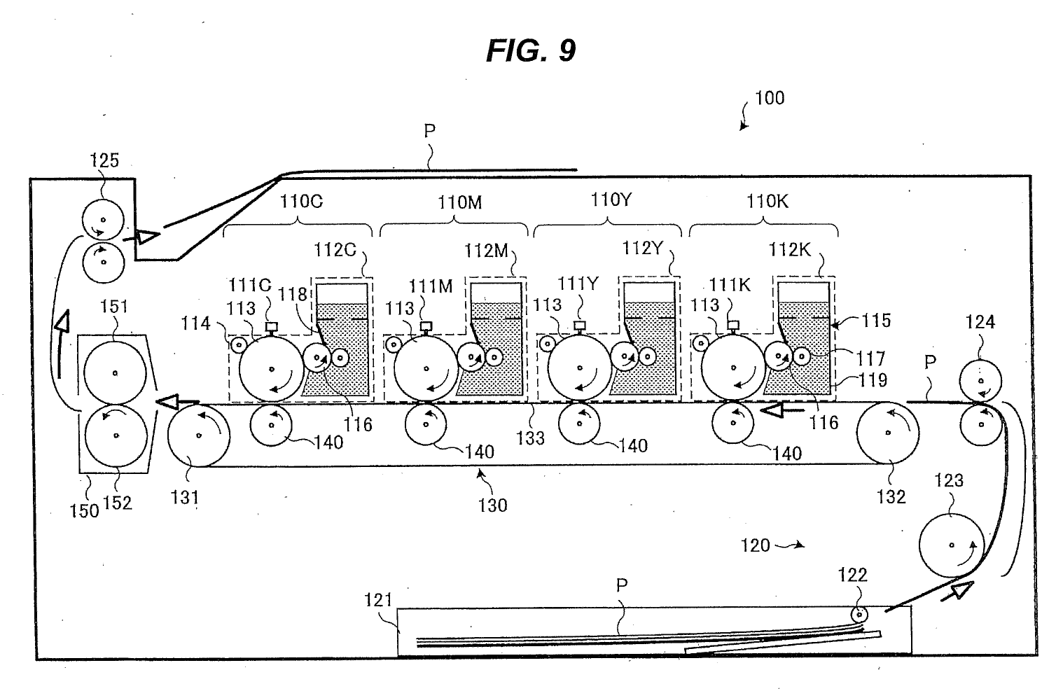

FIG. 9 is a vertical sectional view schematically illustrating an exemplary configuration of an image forming apparatus 100 according to a fifth embodiment. The image forming apparatus 100 according to the fifth embodiment illustrated in FIG. 9 is, for example, an electrophotographic color printer. The image forming apparatus 100 includes LED heads 111K, 111Y, 111M, and 111C (also referred to as the LED heads 111), each of which is the exposure device according to one of the first to fourth embodiments.

As illustrated in FIG. 9, the image forming apparatus 100 includes, as major components: image forming sections 110K, 110Y, 110M, and 110C that form developer images (or toner images) by electrophotography; a medium supply unit (or paper feeding unit) 120 that supplies a recording medium P to the image forming sections 110K, 110Y, 110M, and 110C; a conveying unit 130 that conveys the recording medium P; transfer rollers 140 as transfer units that are arranged to correspond to the respective image forming sections 110K, 110Y, 110M, and 110C, and transfer the toner images onto the recording medium P, which is a sheet member, such as a sheet of paper; a fixing unit 150 as a fixing device that fixes the toner images transferred on the recording medium (or print medium) P onto the recording medium P; and a pair of paper discharging rollers 125 as a medium discharging unit that discharges the recording medium P passing through the fixing unit 150 outside the image forming apparatus 100. FIG. 9 illustrates the four image forming sections 110K, 110Y, 110M, and 110C, but the number of image forming sections in the image forming apparatus 100 may be three or less, or five or more. The image forming apparatus 100 illustrated in FIG. 9 is a color printer, but the image forming apparatus according to the fifth embodiment may be any apparatus that forms an image on a recording medium by electrophotography, such as a monochrome printer having a single image forming section. The image forming apparatus 100 illustrated in FIG. 9 is a printer, but the present invention is also applicable to other apparatuses that form images on recording media by electrophotography, such as copiers, facsimile machines, and multi-function peripherals (MFPs). Specifically, the present invention is applicable to, for example, an MFP obtained by adding other functions, such as a scanning function or facsimile transmitting function, to the image forming apparatus 100.

As illustrated in FIG. 9, the medium supply unit 120 includes: a medium cassette (or paper sheet cassette) 121; a paper feed roller (or hopping roller) 122 that feeds one by one recording media P loaded in the medium cassette 121; a roller (or a registration roller) 123 that conveys the recording medium P fed from the medium cassette 121; and a pair of rollers 124 that convey the recording medium P to the image forming sections 110K, 110Y, 110M, and 110C.

The image forming sections 110K, 110Y, 110M, and 110C form black (K), yellow (Y), magenta (M), and cyan (C) toner images, respectively. The image forming sections 110K, 110Y, 110M, and 110C are arranged along a medium conveying path from the upstream side to the downstream side in a medium conveying direction (indicated by arrows in FIG. 9). The image forming sections 110K, 110Y, 110M, and 110C respectively include detachable image forming units 112K, 112Y, 112M, and 112C for the respective colors. The image forming units 112K, 112Y, 112M, and 112C arranged in series are provided corresponding to the respective colors of the image forming sections 110K, 110Y, 110M, and 110C. The image forming unit 112C forms an image with cyan toner, the image forming unit 112M forms an image with magenta toner, the image forming unit 112Y forms an image with yellow toner, and the image forming unit 112K forms an image with black toner. The image forming units 112K, 112Y, 112M, and 112C basically have the same configuration except for the color of toner.

The image forming sections 110K, 110Y, 110M, and 110C respectively include the LED heads 111K, 111Y, 111M, and 111C as exposure devices for the respective colors. Thus, the image forming apparatus 100 is an LED printer using LED heads as light sources.

Each of the image forming units 112K, 112Y, 112M, and 112C includes: a photosensitive drum 113 as an image carrier supported rotatably about a rotational axis; a charging roller 114 as a charging member that uniformly charges a surface of the photosensitive drum 113; and a developing device 115 that, after the LED head 111 exposes the surface of the photosensitive drum 113 to form an electrostatic latent image thereon, supplies toner to the surface of the photosensitive drum 113 to form a toner image corresponding to the electrostatic latent image.

The developing device 115 includes: a toner container as a developer container that forms a developer storage space for storing the toner; a developing roller 116 as a developer carrier that supplies the toner to the surface of the photosensitive drum 113; a supply roller 117 that supplies the toner stored in the toner container to the developing roller 116; and a developing blade 118 as a toner regulating member that regulates the thickness of a toner layer on a surface of the developing roller 116.

The exposure by the LED head 111 (111K, 111Y, 111M, or 111C) is performed on the uniformly charged surface of the photosensitive drum 113 based on image data for printing. Each of the LED heads 111K, 111Y, 111M, and 111C includes at least one LED array unit in which multiple LEDs (or LED elements) are arranged in an axial direction of the photosensitive drum 113.

As illustrated in FIG. 9, the conveying unit 130 includes: a conveying belt (or transfer belt) 133 that conveys the recording medium P while electrostatically absorbing it; a drive roller 131 that is rotated by a driver to drive the conveying belt 133; and a tension roller (or driven roller) 132 that stretches the conveying belt 133 together with the drive roller 131.

As illustrated in FIG. 9, the transfer rollers 140 are disposed to face the respective photosensitive drums 113 of the image forming units 112K, 112Y, 112M, and 112C with the conveying belt 133 therebetween. The developer images (or toner images) formed on the surfaces of the respective photosensitive drums 113 of the image forming units 112K, 112Y, 112M, and 112C are sequentially transferred by the transfer rollers 140 onto the upper surface of the recording medium P conveyed along the medium conveying path in the direction indicated by the arrows in FIG. 9, so that a color image in which the multiple toner images are superposed is formed.

The fixing unit 150 includes a pair of rollers 151 and 152 in pressure contact with each other. The roller 151 is a heat roller including a heater, and the roller 152 is a pressure roller pressed against the roller 151. The recording medium P with the unfixed developer image (or toner image) passes between the pair of rollers 151 and 152 of the fixing unit 150. At this time, the unfixed toner image is heated and pressed to be fixed onto the recording medium P.

Next, the operation of the image forming apparatus 100 will be described. First, a recording medium P in the medium cassette 121 is fed by the hopping roller 122 to the registration roller 123. Then, the recording medium P is conveyed from the registration roller 123 via the pair of rollers 124 to the conveying belt 133, and conveyed to the image forming units 112K, 112Y, 112M, and 112C in accordance with travel of the conveying belt 133. In the image forming units 112K, 112Y, 112M, and 112C, the surfaces of the photosensitive drums 113 are charged by the charging rollers 114, and exposed by the LED heads 111 (111K, 111Y, 111M, and 111C), so that electrostatic latent images are formed. The thin-layered toners on the developing rollers 116 electrostatically adhere to the electrostatic latent images, so that toner images of the respective colors are formed. The toner images of the respective colors are transferred onto the recording medium P by the transfer rollers 140, so that a color toner image is formed on the recording medium P. Toner remaining on the photosensitive drums 113 after the transfer is removed by cleaning devices (not illustrated). The recording medium (or sheet of paper) P with the color toner image formed thereon is conveyed to the fixing unit 150. In the fixing unit 150, the color toner image is fixed onto the recording medium P, so that a color image is formed. The recording medium P with the toner image formed thereon is discharged to a sheet stacker by the pair of discharging rollers 125.

As described above, the image forming apparatus 100 according to the fifth embodiment employs, as the LED heads, the exposure devices of one of the first to fourth embodiments. Thus, it is possible to easily perform adjustment to eliminate or reduce the difference between the positions in the Z axis direction of the imaging points of light emitted from the LED array units and passing through the lens arrays, around the boundary between the LED unit substrates. Further, according to the fifth embodiment, it is possible to provide a long exposure device by arranging short LED unit substrates and lens arrays, which are low in cost, and configure the adjustment mechanism with a simple structure, thereby providing an image forming apparatus at low cost.

### Sixth Embodiment

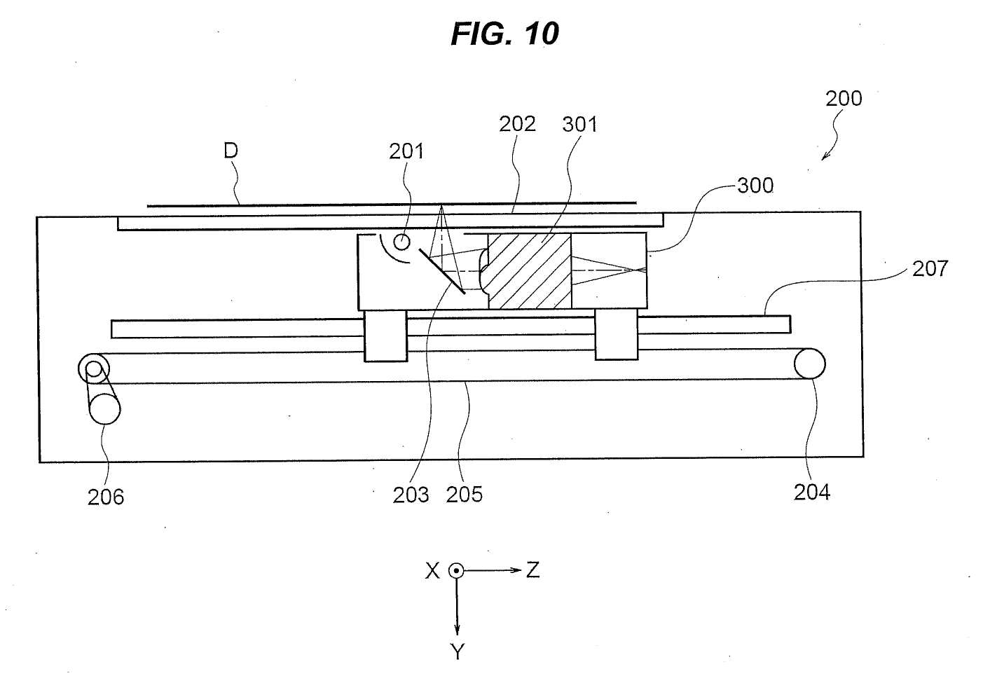

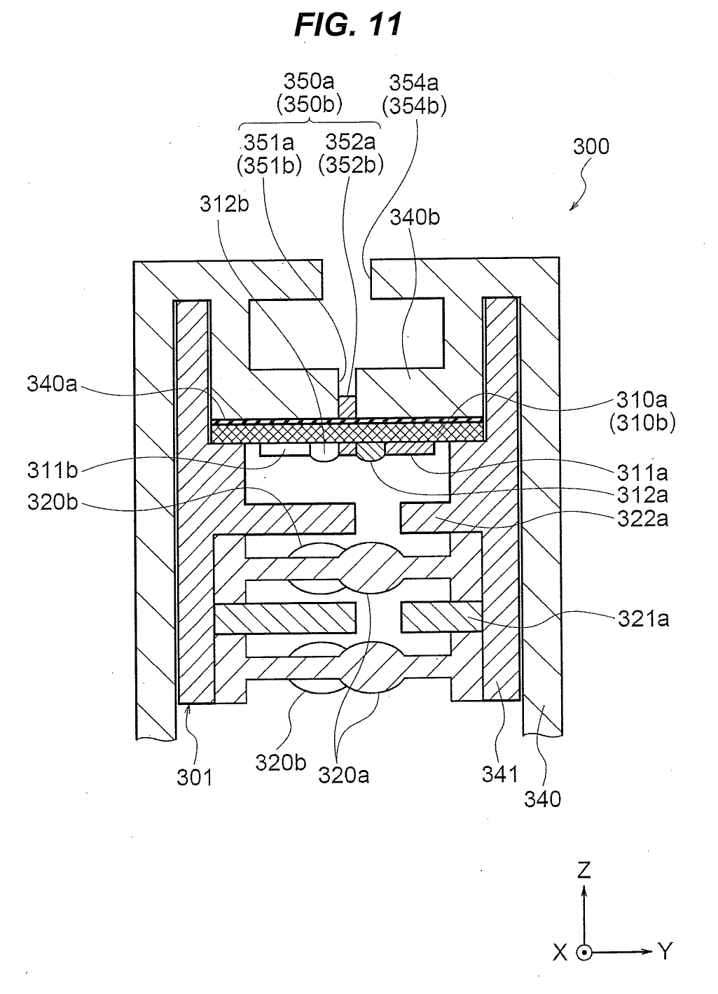

FIG. 10 is a vertical sectional view illustrating an exemplary configuration of a document reading apparatus (or scanner apparatus) 200 including a reading device (or scanning device) 300 according to a sixth embodiment. FIG. 11 is a vertical sectional view schematically illustrating an exemplary configuration of the reading device (or reading head) 300 of the scanner apparatus 200 illustrated in FIG. 10. The reading device according to the sixth embodiment and the scanner apparatus including the reading device will be described below focusing on differences from the first to fourth embodiments.

Roughly speaking, the reading device according to the sixth embodiment is obtained by replacing the light emitting elements of the exposure device according to the first embodiment with light receiving elements, such as photodiodes. The reading device includes a first substrate on which one or more first light receiving element arrays each having multiple light receiving elements are mounted, a first lens array, a second substrate on which one or more second light receiving element arrays each having multiple light receiving elements are mounted, a second lens array, and a holder that holds them. The reading device according to the sixth embodiment differs from the exposure device according to the first embodiment in having the light receiving elements instead of the light emitting elements. Further, due to difference in kind of device and intended use, there are structural differences between the reading device and the exposure device, such as structural differences between the holders. The first substrate and second substrate of the sixth embodiment include the light receiving elements instead of light emitting elements, and are referred to as light receiving unit substrates.

Also in such a reading device, as in the case of the exposure device according to the first embodiment, when multiple light receiving unit substrates or lens arrays are arranged, the difference between the distances (in the Z axis direction) from the light incident surfaces of the lens arrays to the light receiving elements occurs around the boundary between adjacent light receiving unit substrates or lens arrays. The difference leads to noticeable difference in reading accuracy around the boundary.

Thus, the reading device according to the sixth embodiment uses the same concept as the first embodiment, and includes a first adjustment mechanism that adjusts a first distance defined similarly to that of the first embodiment, or the first adjustment mechanism and a second adjustment mechanism that adjusts a second distance defined similarly to that of the first embodiment, thereby eliminating or reducing the difference in reading accuracy around the boundary. Thus, the main features of the reading device according to the sixth embodiment is the same as the main features of the exposure device according to the first embodiment.

The first adjustment mechanism and second adjustment mechanism of the sixth embodiment have the same functions as the first adjustment mechanism and second adjustment mechanism of the first embodiment, and thus may have the same configuration. In the following example, a first screw mechanism and a second screw mechanism are used, but other mechanisms, such as a first cam mechanism and a second cam mechanism, may be used. Further, in the following example, mechanisms that adjust light receiving unit substrates are employed, but mechanisms that adjust lens arrays may be employed, as described in the first embodiment. In addition, various examples described in the first embodiment can be applied to the sixth embodiment.

The scanner apparatus 200 illustrated in FIG. 10 will be described. The scanner apparatus 200 can optically read or scan an image of a document D placed on a platen 202 and output document image data that is electronic data. As illustrated in FIG. 10, the scanner apparatus 200 includes the reading device (or reading head) 300, which is an example of the reading device according to the sixth embodiment, and may further include, for example, a light source 201, the platen 202, a mirror 203, a pulley 204, a drive belt 205, a motor 206, and a rail 207.

The light source 201 illuminates the document D with light. The light source 201 may be, for example, a cold-cathode tube with a molybdenum electrode that has a long life and low power consumption. The platen 202 includes a substantially rectangular member that transmits visible light and forms a document placement surface on which the document D is placed. The mirror 203 is a mirror for folding an optical path of light reflected from the document D. The pulley 204 supports and stretches the endless drive belt 205. A part of the drive belt 205 is connected to the reading head 300 and light source 201. The drive belt 205 is driven by a driving force transmitted from the motor 206 to move the reading head 300 and light source 201. The rail 207 is placed to allow the reading head 300 to move in the Z axis direction parallel to the document placement surface. The rail 207 limits the direction in which the reading head 300 is moved by the drive belt 205.

In the scanner apparatus 200, the light source 201 emits light, which is reflected by a surface of the document D through the platen 202, folded by the mirror 203, and enters the reading head 300. Meanwhile, the motor 206 is driven to drive the drive belt 205, thereby moving the reading head 300 and light source 201 in the Z axis direction and allowing the reading head 300 to receive the reflected light from the entire document D.

Next, the reading head 300 will be described in detail. The reading head 300 receives light emitted from the light source 201 and reflected by the surface of the document D, performs photoelectric conversion on the light by the light receiving elements, and generates an electrical signal corresponding to the image on the document D. Data indicated by the electrical signal or corrected data obtained by performing various image processing on the data may be referred to as document image data.

As illustrated in FIG. 11, the reading head 300 includes a first substrate 310a, a first lens array 320a, a second substrate 310b (behind the first substrate 310a in FIG. 11), a second lens array 320b, and a holder.

The first substrate 310a is a substrate or board on which one or more first light receiving element array units 311a having multiple light receiving elements 312a arranged in the first direction (or X axis direction) is mounted. The first lens array 320a converges or focuses incident light on the first light receiving element array units 311a. The second substrate 310b is spaced from the first substrate 310a in the X axis direction, and is a substrate or board on which one or more second light receiving element array units 311b having multiple light receiving elements 312b arranged in the X axis direction is mounted. The second lens array 320b converges or focuses incident light on the second light receiving element array units 311b. The holder holds the first substrate 310a, first lens array 320a, second substrate 310b, and second lens array 320b. In this example, the holder includes a lens holder 341 and a base 340.

A lens unit 301 illustrated in FIG. 11 includes the first lens array 320a, second lens array 320b, and lens holder 341. The lens unit 301 is fixed to the base 340 with screws, adhesive, or the like (not illustrated). The lens unit 301 may be composed of a lens unit including the first lens array 320a and a lens holder holding it, and a lens unit including the second lens array 320b and a lens holder holding it. In this case, the lens holders of the two lens units are fixed to each other directly or via the base 340.

Each of the first lens array 320a and second lens array 320b is a lens array obtained by arranging, in the X axis direction, multiple pairs of lenses arranging in the Z axis direction, but may have another configuration. Each of the pairs of lenses illustrated in FIG. 11 is composed of a first lens plate that forms a reduced inverted image based on light reflected by the mirror 203, and a second lens plate that enlarges and inverts the reduced inverted image formed by the first lens plate to form an enlarged inverted image. In the reading head 300 illustrated in FIG. 11, the first lens array 320a includes a light blocking plate 321a between the first lens plate and the second lens plate, and the lens unit 301 includes a mask 322a between the first substrate 310a and the second lens plate.

The base 340 has a shape such that the lens unit 301 can be mounted on the base 340, and has a mounting stage 340b on which the first substrate 310a and second substrate 310b are mounted. An insulating sheet 340a is placed on a mounting surface of the mounting stage 340b, and the first substrate 310a is placed on the insulating sheet 340a. Then, the lens holder 341 is mounted on the base 340 while abutting against regions of both ends of the first substrate 310a in the Y axis direction except for at least an end of the first substrate 310a in the X axis direction, so that the first substrate 310a is mounted. The second substrate 310b is mounted in the same way as the first substrate 310a.

Regarding positioning of the first lens array 320a and first substrate 310a in the Y axis direction and positioning of the second lens array 320b and second substrate 310b in the Y axis direction, the description of the first embodiment can be used. For example, the positioning may be performed so that light from the first lens array 320a is converged at the light receiving elements 312a of the first substrate 310a and light from the second lens array 320b is converged at the light receiving elements 312b of the second substrate 310b, or light from the first lens array 320a and light from the second lens array 320b are converged at different positions in the Y axis direction. The first lens array 320a and second lens array 320b may be inclined to each other so that their optical axes intersect each other at an intermediate position between the position of the first light receiving element array units 311a (or light receiving elements 312a) in the Y axis direction and the position of the second light receiving element array units 311b (or light receiving elements 312b) in the Y axis direction. The internal structures (shapes and arrangement of optical parts) of the first lens array 320a and second lens array 320b may be configured so that the optical axes intersect each other at the intermediate position.

The reading head 300 includes, as a main feature thereof, a first screw mechanism 350a in the holder. The first screw mechanism 350a adjusts the first distance between the first lens array 320a and the first light receiving element array units 311a. As illustrated in FIG. 11, the first screw mechanism 350a may include a threaded hole 351a formed in the mounting stage 340b of the base 340, and an adjustment screw 352a that is screwed into the threaded hole 351a. As illustrated in FIG. 11, to insert a tool, such as a hexagon wrench or a screwdriver, for rotating the screw 352a, a through hole 354a is formed in the base 340 at a position corresponding to the screw 352a. The reading head 300 may also include a second screw mechanism 350b that includes a threaded hole 351b and a screw 352b and adjusts the second distance between the second lens array 320b and the second light receiving element array unit 311b. In this case, a through hole 354b like the through hole 354a is formed in the base 340.

Regarding the structures of the first screw mechanism 350a and second screw mechanism 350b and the adjustment method thereby, the description regarding the first screw mechanism 50a and second screw mechanism 50b of the first embodiment can be used. The through holes 354a and 354b are filled with sealing material after the adjustment.

As described above, according to the sixth embodiment, when multiple light receiving unit substrates and multiple lens arrays are arranged, it is possible to easily adjust the position at which the light receiving element array unit receives light from the lens array, thereby eliminating or reducing the difference in reading accuracy around the boundary between adjacent light receiving unit substrates or the boundary between adjacent lens arrays.

By mounting the reading device according to the sixth embodiment or the scanner apparatus including the reading device on, for example, the image forming apparatus 100 according to the fifth embodiment, it is possible to provide a multi-function apparatus having a scanning function and a copying function in addition to the printing function. As such, the reading device may be provided in a multi-function apparatus.

In the above example, the reading device according to the sixth embodiment is obtained by replacing the light emitting elements of the exposure device according to the first embodiment with light receiving elements, but it may be obtained by replacing the light emitting elements of the exposure device according to one of the second to fourth embodiments with light receiving elements. The reading device according to the sixth embodiment may have the features of one of the second to fourth embodiments. In addition, various examples described in the second to fourth embodiments can be applied to the sixth embodiment.

The present invention is not limited to the embodiments described above; it can be practiced in various other aspects without departing from the inventive scope.

What is claimed is:

1. An exposure device comprising:
a first light emitting element;
a first lens array that converges light emitted from the first light emitting element;
a second light emitting element spaced a predetermined distance from the first light emitting element;
a second lens array that converges light emitted from the second light emitting element;
a holder that holds the first light emitting element, the first lens array, the second light emitting element, and the second lens array; and
a first adjustment mechanism that is provided in the holder and adjusts a first distance between the first lens array and the first light emitting element.

2. The exposure device of claim 1, further comprising:
a first substrate on which a first light emitting element array unit including a plurality of first light emitting elements including the first light emitting element is mounted, the plurality of first light emitting elements being arranged in a first direction; and
a second substrate on which a second light emitting element array unit including a plurality of second light emitting elements including the second light emitting element is mounted, the plurality of second light emitting elements being arranged in the first direction, the second substrate being spaced from the first substrate in the first direction.

3. The exposure device of claim 2, wherein the first adjustment mechanism displaces an end in the first direction of the first substrate in at least one of a direction toward the first lens array and a direction away from the first lens array.

4. The exposure device of claim 2, wherein the holder has a space that allows at least one of displacement of an end in the first direction of the first substrate toward the first lens array and displacement of the end in the first direction of the first substrate away from the first lens array.

5. The exposure device of claim 2, wherein the first substrate has a first notched portion extending along the first light emitting element array unit from an end in the first direction of the first substrate.

6. The exposure device of claim 2, wherein the first light emitting element array unit is mounted on the first substrate so that one end in the first direction of the first light emitting element array unit projects from an end in the first direction of the first substrate.

7. The exposure device of claim 2, wherein an end in the first direction of the first substrate has a first projection on which one end in the first direction of the first light emitting element array unit is mounted.

8. The exposure device of claim 1, further comprising a second adjustment mechanism that is provided in the holder and adjusts a second distance between the second lens array and the second light emitting element.

9. The exposure device of claim 8, further comprising:
a first substrate on which a first light emitting element array unit including a plurality of first light emitting elements including the first light emitting element is mounted, the plurality of first light emitting elements being arranged in a first direction; and
a second substrate on which a second light emitting element array unit including a plurality of second light emitting elements including the second light emitting element is mounted, the plurality of second light emitting elements being arranged in the first direction, the second substrate being spaced from the first substrate in the first direction.

10. The exposure device of claim 9, wherein the second adjustment mechanism displaces an end in the first direction of the second substrate in at least one of a direction toward the second lens array and a direction away from the second lens array.

11. The exposure device of claim 8, wherein the second adjustment mechanism includes a screw mechanism that adjusts the second distance.

12. The exposure device of claim 8, wherein the second adjustment mechanism includes a cam mechanism that adjusts the second distance.

13. The exposure device of claim 9, wherein the holder has a space that allows at least one of displacement of an end in the first direction of the second substrate toward the second lens array and displacement of the end in the first direction of the second substrate away from the second lens array.

14. The exposure device of claim 9, wherein the second substrate has a second notched portion extending along the second light emitting element array unit from an end in the first direction of the second substrate.

15. The exposure device of claim 9, wherein the second light emitting element array unit is mounted on the second substrate so that one end in the first direction of the second light emitting element array unit projects from an end in the first direction of the second substrate.

16. The exposure device of claim 7, further comprising a second adjustment mechanism that is provided in the holder and adjusts a second distance between the second lens array and the second light emitting element,
wherein an end in the first direction of the second substrate has a second projection on which one end in the first direction of the second light emitting element array unit is mounted, and
wherein the holder holds the first substrate and the second substrate so that the first projection at least partially overlaps the second projection in the first direction.

17. The exposure device of claim 2, wherein:
the plurality of first light emitting elements in the first light emitting element array unit are equally spaced with a first spacing;
the plurality of second light emitting elements in the second light emitting element array unit are equally spaced with a second spacing;
the second spacing is equal to the first spacing; and
the holder holds the first substrate and the second substrate so that a distance in the first direction between one of the first light emitting elements of the first light emitting element array unit closest to the second substrate and one of the second light emitting elements of the second light emitting element array unit closest to the first substrate is equal to the first spacing.

18. The exposure device of claim 1, wherein the first light emitting element and the second light emitting element are light emitting diodes.

19. An image forming apparatus comprising:
the exposure device of claim 1; and
an image carrier that is exposed by the exposure device and on which an electrostatic latent image is formed.

20. A multi-function apparatus comprising the image forming apparatus of claim 19.
